(19) United States
(12) Patent Application Publication
(10) Pub. No.: US 2005/0138231 A1
(43) Pub. Date: Jun. 23, 2005

(54) Information processing device, information processing system, transmission rate setting method, transmission rate setting computer program, and storage medium containing computer program

(75) Inventors: Takeshi Yamaguchi, Yamatokoriyama-shi (JP); Motohiro Hayashi, Nara-shi (JP); Yoshinori Hayashi, Soraku-gun (JP); Yoshikazu Kondoh, Izumiotsu-shi (JP); Masakazu Suzuki, Yamatokoriyama-shi (JP); Kazunori Miyamoto, Kashihara-shi (JP)

Correspondence Address: EDWARDS & ANGELL, LLP, P.O. BOX 55874, BOSTON, MA, 02205, US

(73) Assignee: Sharp Kabushiki Kaisha, Osaka (JP)

(21) Appl. No.: 11/020,325

(22) Filed: Dec. 22, 2004

(30) Foreign Application Priority Data
Dec. 22, 2003 (JP) 2003-425079

(51) Int. Cl. G06F 3/00

(52) U.S. Cl. 710/15

(57) ABSTRACT

An information processing device is provided where in communications between the information processing device and another information processing device, the transmission rate of a communications interface of the information processing device is automatically set in accordance with a transmission rate at which the communications interface of the other information processing device is operable, for communications. A printer device holds a USB driver information managing table and/or a USB hardware information managing table which are lists of information related to a driver and/or hardware of a USB interface. The printer device obtains, from the host PC, printer device USB driver/hardware information which is information on a driver and/or hardware of a USB/IF of the host PC. The printer device checks a communications mode in which the USB/IF of the host PC is operable by comparing the printer device USB driver/hardware information and the USB driver information managing table and/or USB hardware information managing table. In accordance with results of the checking, the printer device determines a communications mode for the USB/IF of the printer device.

This Nonprovisional application claims priority under 35 U.S.C. § 119(a) on Patent Application No. 2003-425079 filed in Japan on 22 Dec. 2003, the entire contents of which are hereby incorporated by reference.

### FIELD OF THE INVENTION

The present invention relates to information processing devices communicably connected to another information processing device, in particular, for example, peripherals communicably connected to a PC (personal computer), as well as to information processing systems, transmission rate setting methods, transmission rate setting computer programs, and storage media containing such a computer program.

### BACKGROUND OF THE INVENTION

Personal computers and other information processing devices are boasting increasingly high performance. In these situations, the information processing devices are required to process a wide variety of information. The wide variety of information, or data, is transferred between the information processing device and various peripherals. Communications interfaces (hereinafter, “communications IFs”) used in data transfer are also developing.

Some examples of diverse communications IFs in development are RS-232c interfacing between an information processing device main body and a modem, SCSI (Small Computer System Interface), IDE (Integrated Device Electronics), USB (Universal Serial Bus), and IEEE 1394 which connect an information processing device main body to hard disks and scanners.

For a data transfer between an information processing device and its peripheral through a communications IF, drivers are needed to control the communications IF and the peripheral, so that the devices can communicate with each other.

If these drivers are not preinstalled in the information processing device, the information processing device needs to externally obtain necessary drivers and appropriately set up the drivers. In conventional cases, the drivers are stored on a floppy (registered trademark) disk, CD-ROM, or other storage medium that comes with the peripheral. The drivers are installed in the information processing device from that medium.

For example, Japanese unexamined patent application 2003-122699 (Tokukai 2003-122699; published on Apr. 25, 2003) teaches a configuration of a peripheral. According to the configuration, the peripheral has its driver stored in itself. Upon connecting to an information processing device, the peripheral automatically installs the driver in the information processing device.

Incidentally, high speed, high performance communications IFs are being developed one after the other, operating under progressively higher levels of standards. A problem arises if either the information processing device or the peripheral is not compliant with the higher level of communications IF standards: the information processing device fails to communicate with the peripheral.

For example, USB 2.0 provides a new communications mode termed “high speed mode,” in addition to the existing communications modes for two transmission rates, “full speed mode” and “low speed mode,” which were provided in the older USB 1.1 standard.

A communications mode refers to a scheme indicating a data transfer capability. Low speed mode can handle a transmission rate of 1.5 Mbps (megabits per second). Full speed mode can handle 12 Mbps. High speed mode can handle 480 Mbps.

Suppose that the peripheral can operate in USB high speed mode and is set up to operate in that mode. If the information processing device is not compliant with high speed mode, the devices cannot communicate when powered on.

Communications problems can still occur if the information processing device is compliant with high speed mode, because of possible poor compatibility between the USB/IF hardware or driver of the information processing device and the communications IF of the peripheral.

To prevent these problems from happening, conventional peripherals are set up, when shipped out from a factory, to operate in full speed mode. With the settings, the peripheral can communicate with an information processing device via both USB 1.1 and USB 2.0, regardless of the compatibility between the communications IFs.

According to the Tokukai 2003-122699 configuration, the peripheral has its driver stored in itself. Upon connecting to an information processing device, the peripheral automatically installs the driver in the information processing device. However, Tokukai 2003-122699 is silent about the setup of the communications IF drivers.

Therefore, as mentioned above, when the peripheral connects to the information processing device, communications fails if the communications IFs in the devices are set up to carry out communication in individually different modes.

As mentioned above, when shipped out of a factory, the peripheral is set up to operate in a communications mode in which conventional communications IFs are operable. Thus, problematic situations are avoided where the peripheral cannot communicate with an information processing device because their communications IFs are set up to carry out communication in individually different modes.

In such a conventional approach, for example, an information processing device and a peripheral, each equipped with a communications IF operational in high speed mode, are forced to communicate in full speed mode if the communications IF of the peripheral cannot switch to different, suitable transmission rate settings when establishing communication. In short, the data transfer capability of the devices is not effectively used for communications.

For these reasons, it is preferable if the communications IF of the peripheral can automatically switch between different sets of communications mode settings in accordance with the communications mode that can be handled by the information processing device when establishing communication between the peripheral and the information processing device.

### SUMMARY OF THE INVENTION

In view of these problems, the present invention has an objective to provide such an information processing device that in communications between the information processing device and another information processing device, the transmission rate of the communications IF of the information processing device is automatically set in accordance with a transmission rate at which the communications interface of the other information processing device is operable, for communications; an information processing system which involve the information processing device and the other information processing device, transmission rate setting method, and transmission rate setting program; and a storage medium containing the program.

To achieve the objective, an information processing device in accordance with the present invention is an information processing device communicably connected to another information processing device, and is characterized by including: a communications interface list storage section for storing a communications interface information list recording a relationship between multiple sets of communications interface information which are information related to a driver and/or hardware of a communications interface and a communicable transmission rate; a correspondent communications interface information obtaining section for requesting and obtaining correspondent communications interface information which is communications interface information on a communications interface of the other information processing device from the other information processing device; a correspondent communications capability check section for checking a communicable transmission rate of the communications interface of the other information processing device in reference to the correspondent communications interface information and the communications interface information list; and a transmission rate determine section for determining a setting related to a transmission rate of a communications interface of the information processing device in accordance with a result of the checking by the correspondent communications capability check section.

The provision of the communications interface information obtaining section enables the information processing device to obtain the correspondent communications interface information regarding the communications interface of the other information processing device from the other information processing device. The correspondent communications capability check section further enables the information processing device to check the communicable transmission rate capability of the communications interface of the other device in reference to, the obtained correspondent communications interface information and the communications interface list stored in the communications interface list storage section.

In other words, the correspondent communications capability check section compares the communications interface information in the communications interface information list with the correspondent communications interface information to check the communicable transmission rate of the communications interface associated with the communications interface information on the communications interface list to know the communicable transmission rate of the communications interface of the other information processing device. Based on a result of the checking, the transmission rate determine section can decide the transmission rate setting of a communications interface of the information processing device.

In other words, in cases where the information processing device is so configured to check the communicable transmission rate capability of the communications interface corresponding to the driver information from the information related to the driver of the communications interface of the information processing device, the information processing device can determine the transmission rate setting of the communications interface of the information processing device by obtaining information related to the driver of the communications interface of the other information processing device from that device as communications interface information.

In addition, in cases where the information processing device is so configured to check the transmission rate capability of the corresponding communications interface from the information related to the hardware of the communications interface of the information processing device, the information processing device can determine the transmission rate setting of the communications interface of the information processing device by obtaining information related to the hardware of the communications interface of the other information processing device from that device as communications interface information.

In addition, in cases where the information processing device is so configured to check the transmission rate capability of the corresponding communications interface from the information related to the hardware and driver of the communications interface, the information processing device can determine the transmission rate setting of the communications interface of the information processing device by obtaining information related to the hardware and driver of the communications interface of the other information processing device from that device as communications interface information.

Therefore, even if in the communications between the information processing device and the other information processing device, the transmission rate capabilities of the communications interfaces of the devices differ from each other, communications in accordance with the transmission rate capabilities of a communications interface of the two information processing devices becomes possible.

A communications interface refers to, for example, a SCSI (small computer system interface), USB (universal serial bus), or IEEE 1394 interface connecting to a hard disk or scanner. It is hardware providing a communicable connection between devices. A driver for the communications interface refers to software controlling the communications interface.

In addition, a transmission rate at which the communications interface can operate refers to a data transfer rate between an information processing device and another information processing device in communications between the devices. For example, if the communications interface is compliant with USB specifications, the transmission rate is 1.5 Mbps (megabits per second) in low speed mode, 12 Mbps in full speed mode, and 480 Mbps in high speed mode.

In addition, information related to the driver which constitutes the communications interface information list refers to information enabling the information processing device to identify the driver.

Meanwhile, information related to the hardware refers to information for identifying the hardware of the communications interface, such as model information of the communications interface.

The communications interface information list records the communicable transmission rate of the communications interface associated with the multiple sets of communications interface information.

The transmission rate capability list may be constituted by either of the driver information and hardware information related to the communications interface and information related to the communicable transmission rate of an associated communications interface, or both.

In addition, to achieve the objective, an information processing device in accordance with the present invention is an information processing device communicably connected to another information processing device, and is characterized by including: an information processing device communications interface information storage section for storing information processing device communications interface information representing a relationship between communications interface information which is information related to a driver and/or hardware of a communications interface with respect to the information processing device and a communicable transmission rate; an information processing device communications interface check section for checking a transmission rate of a communications interface of the information processing device on the basis of communications interface information of the information processing device; and a transmission rate setting alteration request section for requesting the other information processing device to alter a transmission rate setting of a communications interface of the other information processing device in accordance with a result of the checking by the information processing device communications interface check section.

Therefore, the information processing device can give an instruction to the other information processing device to alter the transmission rate setting of the communications interface of the other information processing device in accordance with the communicable transmission rate of the communications interface of the information processing device.

Additional objects, advantages and novel features of the invention will be set forth in part in the description which follows, and in part will become apparent to those skilled in the art upon examination of the following or may be learned by practice of the invention.

### BRIEF DESCRIPTION OF THE DRAWINGS

FIG. 1, depicting an embodiment of the present invention, is a block diagram illustrating the configuration of a major part of a printer device in an example of a USB/IF communications mode setting process.

FIG. 2, depicting an embodiment of the present invention, is a block diagram illustrating the configuration of a major part of a host PC in an example of a USB/IF communications mode setting process.

FIG. 3 is a schematic block diagram illustrating, as an example, the configuration of a printer device and a host PC in a printer system in accordance with embodiment of the present invention.

FIG. 4(a) lists, as an example, information on USB/IF drivers with which the USB/IF of the printer device can communicate.

FIG. 4(b) lists, as an example, information on USB/IF hardware with which the USB/IF of the printer device can communicate.

FIG. 5 is a flow chart illustrating, as an example, a process related to communications mode settings of the USB/IF of the printer device in the establishing of communications between the printer device and the host PC.

FIG. 6 is a block diagram illustrating, as an example, the configuration of a major part of a USB communications control section related to a communications establishing process.

FIG. 7 is a flow chart illustrating, as an example, a communications establishing process implemented by the printer device with respect to the host PC.

FIG. 8 is a flow chart illustrating, as an example, a process of updating a list of USB driver information managing tables and USB hardware information managing tables in accordance with an embodiment of the present invention.

FIG. 9 is a flow chart illustrating, as an example, a process related to communications mode settings of the USB/IF of the printer device in the establishing of communications between the printer device and the host PC in accordance with another embodiment of the present invention.

FIG. 10 is a schematic block diagram illustrating, as an example, the configuration of a printer device and a host PC in a printer system in accordance with another embodiment of the present invention.

FIG. 11, depicting another embodiment of the present invention, is a block diagram illustrating the configuration of a major part of a printer device in an example of a USB/IF communications mode setting process.

FIG. 12, depicting another embodiment of the present invention, is a block diagram illustrating the configuration of a major part of a host PC in an example of a USB/IF communications mode setting process.

### DESCRIPTION OF THE EMBODIMENTS

Embodiment 1

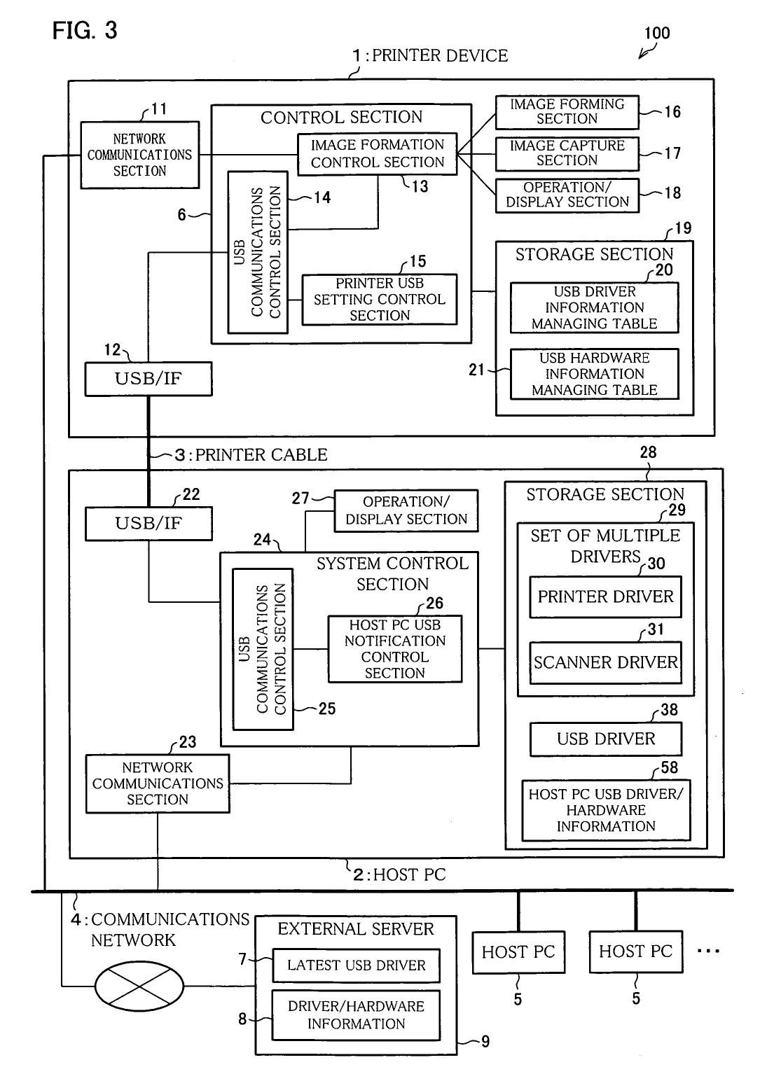

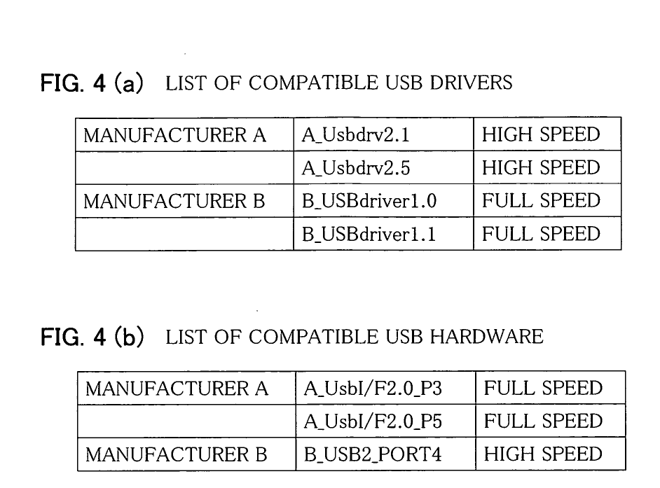

An embodiment of the present invention will be now described. FIG. 3 is a schematic drawing, as an example, the configuration of a printer device 1 and a host PC 2 in a printer system 100 in accordance with the present embodiment. FIGS. 4(a), 4(b) list, as an example, information on USB/IF drivers and hardware on a device with which the printer device 1 can communicate through a USB interface (hereinafter, “USB/IF”) 12.

The printer device 1 in accordance with the present embodiment is a multifunction printer that combines functions of copying machine, facsimile, scanner, etc. in one unit. As shown in FIG. 3, the printer device 1 is mutually connected with the host PC (Personal Computer) 2 in accordance with the present embodiment via a printer cable 3. The printer device 1 and host PC 2 are configured so that they can also externally communicate with other host PCs 5 and servers 9 over a communications network 4.

The printer device 1 contains a network communications section 11, the USB/IF 12, a control section 6, an image forming section 16, an image capture section 17, an operation/display section 18, and a storage section 19.

The network communications section 11 enables the printer device 1 to exchange data with external host PCs 5 or servers 9 over the communications network 4 in accordance with instructions from the control section 6.

The USB/IF 12 is a communications interface connecting the printer device 1 to the external host PC 2 via the printer cable 3 so that the device 1 and the PC 2 can mutually transmit/receive data. In other words, the printer device 1 establishes a connection with the host PC 2 via the USB/IF 12 in accordance with instructions from a USB communications control section 14 in the control section 6, before a data transmission/reception with the host PC 2.

In the connection to the host PC 2, the USB/IF 12 of the printer device 1 is compatible up to high speed communications mode provided in USB 2.0. Meanwhile, it is unknown whether the communications IF, or the USB/IF 22, of the host PC 2 which will be involved in communications is compatible up to high speed mode.

Thus, for the first round of communications with the host PC 2, the printer device 1 operates in full speed communications mode which is backward compatible with conventionally popular USB 1.1. A full speed mode setting process will be detailed later.

Communications modes, including high speed, full speed mode, etc., refer to a scheme indicating a data transfer capability. Low speed mode can handle a transmission rate of 1.5 Mbps. Full speed mode can handle 12 Mbps. High speed mode can handle 480 Mbps.

The image forming section 16 is for printing, for example, images based on data coming from the host PC 2 over the USB/IF 12 or the network communications section 11 and image data captured by the image capture section 17 in accordance with instructions from an image formation control section 13 on paper and other printable materials (hereinafter, “paper”).

The materials are fed from a paper feed tray (not shown) inside the printer device 1 where image-printable paper is stored. After the printing in the image forming section 16, the paper is discharged to a paper discharge tray (not shown).

The operation/display section 18 allows the user to enter operation commands for the printer device 1: for example, image capture and function switching commands. To facilitate manipulation by the user, an operation menu, status, and other information on the printer device 1 may be graphically displayed.

For example, when the user enters an image capture command to the printer device 1, the user command is sent to the image formation control section 13 via the operation/display section 18. The image formation control section 13 then controls the image capture section 17 so that the section 17 captures the image wanted by the user. As the image capture section 17 captures the image wanted by the user, the data on the captured image is stored in the storage section 19.

The storage section 19 is a rewriteable non-volatile storage medium storing data on the image captured by the image capture section 17 and data obtained from the external server 9, etc. In addition, the storage section 19 contains a USB driver information managing table 20 based on which is managed driver information for the USB/IFs compatible with the USB/IF 12 and a USB hardware information managing table 21 based on which is managed hardware information for the USB/IFs compatible with the USB/IF 12.

As shown in FIG. 4(a), the USB driver information managing table 20 contains a list of the names of the manufacturers of the drivers for the USB/IFs communicable via the USB/IF 12 and information identifying those USB/IF drivers. Information identifying the USB/IF drivers, for example, indicates the types or content of control programs for the USB/IFs.

As shown in FIG. 4(b), the USB hardware information managing table 21 contains a list of the manufacturers of the USB/IFs compatible with the USB/IF 12 and hardware information for the USB/IFs. Hardware information, for example, refers to information on USB/IF hardware models.

FIG. 4(a) and FIG. 4(b) show communications modes in which the USB/IF is operable that are equivalent to the information identifying drivers and hardware. As shown in FIG. 4(a) and FIG. 4(b), the storage section 19 contains so much as to include these compatible communications modes. This is by no means limiting the invention.

For example, the storage section 19 may store information on the compatible USB/IF drivers and their manufacturers in the USB driver information managing table 20 and information on the compatible USB/IF hardware and their manufacturers in the USB hardware information managing table 21.

In this case, upon an input of the information related to the USB/IF drivers and hardware, the performance at a transmission rate compatible with the USB/IF corresponding to the information stored in a program is read out.

The control section 6 controls the printer device 1 to execute various processes. The control section 6 is equipped with the image formation control section 13, the USB communications control section 14, and a printer USB setting control section 15.

The image formation control section 13 controls the image forming section 16 and/or the image capture section 17 in accordance with incoming user commands. For example, as mentioned above, the section 13 receives print and other instructions from the external host PC 2 and/or 5 via the operation/display section 18, the communications network 4, or the printer cable 3. In accordance with the instructions, the image forming section 13, for example, controls the image forming section 16 so that an image can be printed based on incoming image data from the host PC 2 and/or host PC 5.

The USB communications control section 14 connects and disconnects to the host PC 2 via the USB/IF 12 over the printer cable 3 and prepares data before a transfer. The USB communications control section 14 will be detailed later.

The printer USB setting control section 15 decides transmission rate settings for a connection to the host PC 2. The USB setting control section 15 will be detailed later.

Now will be described the configuration of the host PC 2 connected to the printer device 2. As shown in FIG. 3, the host PC 2 includes a USB/IF 22, a network communications section 23, a system control section 24, an operation/display section 27, and a storage section 28.

The USB/IF 22 is a communications IF connecting the host PC 2 to the external printer device 1 via the printer cable 3 so that the PC 2 and the device 1 can mutually transmit/receive data. In other words, the host PC 2 establishes a connection with the printer device 1 via the USB/IF 22 in accordance with instructions from the system control section 24, before a data transmission/reception with printer device 1.

The network communications section 23 enables the PC 2 to exchange data with the external host PCs 5 or server 9 over the communications network 4 in accordance with instructions from the system control section 24.

The operation/display section 27 is a keyboard, a mouse, and/or other external input means which allows the user to enter operation commands for the printer device 1: for example, commands to print from image data stored on the PC 2. The section 27 encompasses a monitor and other display means which allows a display of the user operation through the external input means and the data stored in the storage section 28.

The storage section 28 is a rewriteable non-volatile storage medium, for example, a hard disk. The storage section 28 contains a set of multiple drivers 29 (printer driver 30, scanner driver 31, etc.) and a USB driver 38. The storage section 28 further contains host PC USB driver/hardware information 58 with respect to the USB driver 38.

The host PC USB driver/hardware information 58 identifies the driver and hardware of the USB/IF 22 and their manufacturers. This driver-specific information, for example, indicates the type or content of a control program for the USB/IF 22. The hardware-specific information, for example, refers to the model number of the USB/IF 22 hardware.

In other words, the host PC USB driver/hardware information 58 is related to the USB/IF 22's driver and hardware. The information 58 is, for example, information identifying the driver and its manufacturer and information identifying the hardware and its manufacturer.

The set of multiple drivers 29 is software controlling the multifunction printer device 1. For example, the system control section 24 converts image and other data in the host PC 2 into data compatible with the printer device 1 by reading out the set of multiple drivers 29 from the storage section 28. The system control section 24 then makes the image data printable with the printer device 1.

In addition, the USB driver 38 is software realizing communications between the USB/IF 12 of the printer device 1 and the USB/IF 22 of the host PC 2.

The system control section 24 manages the system for the host PC 2, controlling and executing various processes. The system control section 24 includes a USB communications control section 25 and a host PC USB notification control section 26.

The USB communications control section 25 connects and disconnects to the printer device 1 via the USB/IF 22 over the printer cable 3 and prepares data before a transfer.

The host PC USB notification control section 26 controls to notify the printer device 1 of the information on the USB/IF 22 driver and hardware of the host PC 2 (host PC USB driver/hardware information 58). The host PC USB notification control section 26 will be detailed later.

The printer system 100 is made up of the printer device 1 and the host PC 2 which are configured as in the foregoing. The printer device 1 therefore can receive image data from the host PC 2 or the host PCs 5 and print an image from the image data.

Assume, for example, that the user of the host PC 2 wants to print an image prepared on the host PC 2. The user enters a print command with respect to a desired image through the operation/display section 27. The user command is fed to the system control section 24 via the operation/display section 27. The system control section 24 reads out the data of the image wanted by the user from the storage section 28 to transmit print command together with the image data to the printer device 1.

Meanwhile, as the printer device 1 receives the image data and the print command from the host PC 2 via the USB/IF 12, the image formation control section 13 gives print instructions to the image forming section 16 based on the image data. The image forming section 16 can now print the image wanted by the user of the host PC 2 in accordance with the instructions from the image formation control section 13.

Assume another case where copies of the image captured by the image capture section 17 are made. The printer device 1 implements an image print process with respect to the image forming section 16 based on the data of the image captured by the image capture section 17 in accordance with the instructions from the image formation control section 13.

The functions of the printer device 1 are not limited the printing, scanning, and copying of an image. For example, the printer device 1 may have a facsimile function whereby either a captured image or an image transmitted from the host PC 2 is transmitted to an external facsimile over telephone lines.

(USB/IF Communications Mode Setting Process in Printer Device)

Next will be described a process of setting up the USB/IF 12 of the printer device 1 in establishing a connection between the printer device 1 and the host PC 2 configured as in the foregoing.

Here, as mentioned above, the USB/IF 12 of the printer device 1 is compatible with the communications modes up to high speed mode. Meanwhile, the communications mode(s) that can be handled by the USB/IF 22 of the party to which the host PC 2 will connect is unknown.

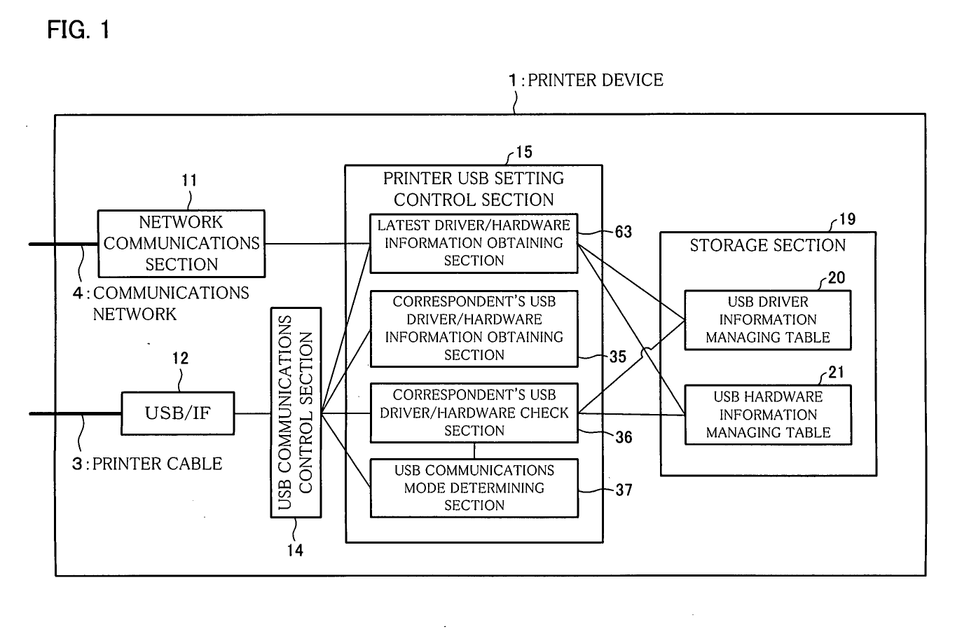

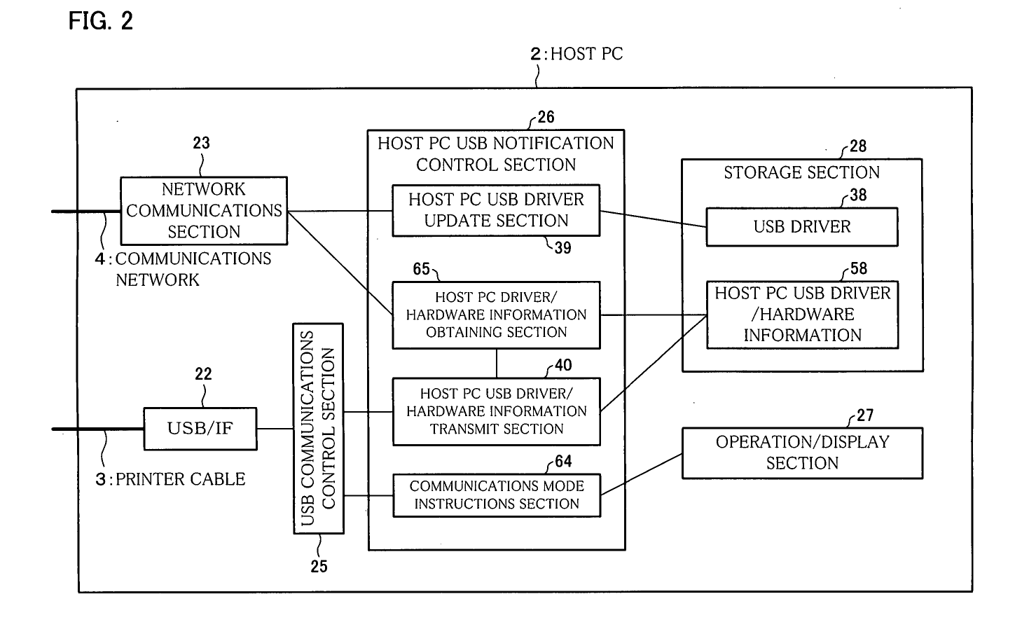

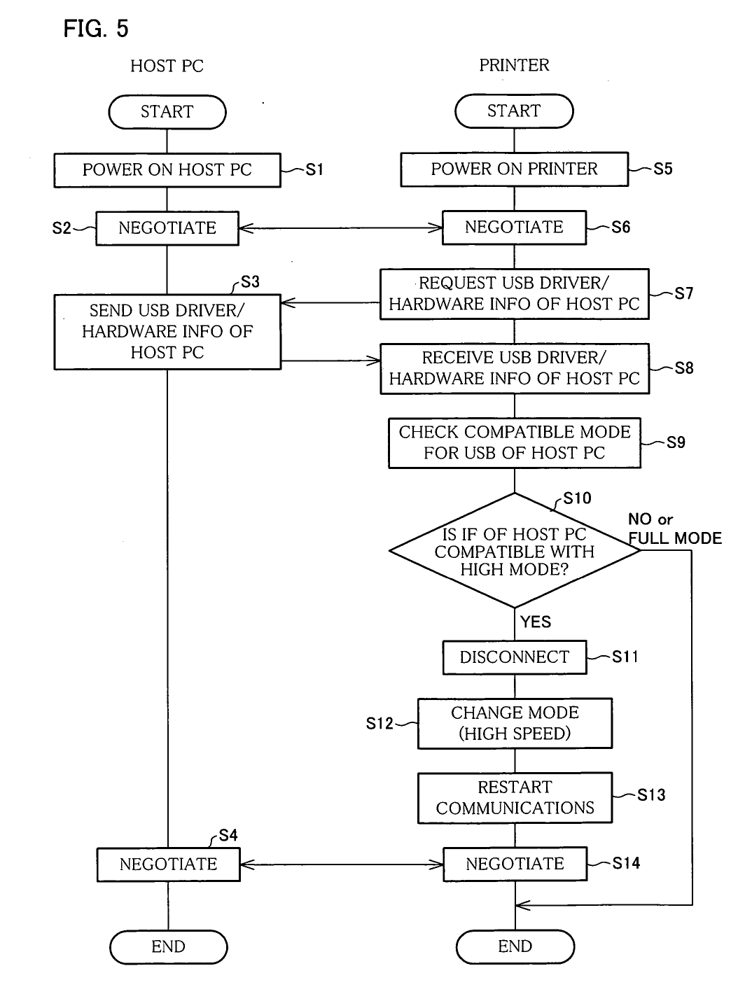

FIG. 1 is a schematic illustrating the configuration of the printer device 1 in relation to an example of a communications mode setting process for the USB/IF 12. FIG. 2 is a schematic drawing illustrating the configuration of the host PC 2 in relation to an example of the communications mode setting process for the USB/IF 12. FIG. 5 is a flow chart illustrating a process flow in relation to the communications mode settings of the USB/IF 12 of the printer device 1 in establishing a connection between the printer device 1 and the host PC 2.

Referring to FIG. 1, the printer USB setting control section 15 in the printer device 1 contains a latest driver/hardware information obtaining section 63, a correspondent USB driver/hardware information obtaining section 35, a correspondent USB driver/hardware check section 36, and a USB communications mode determining section 37.

FIG. 1 shows only those members related to the communications mode setting process for the USB/IF 12 for a clear illustration. The image formation control section 13, the image forming section 16, the image capture section 17, and the operation/display section 18 shown in FIG. 3 are omitted.

The latest driver/hardware information obtaining section 63 obtains latest USB/IF driver/hardware information 8 stored in the external server 9 via the network communications section 11 over the communications network 4. The driver/hardware information 8, for example, identifies the USB/IF driver and hardware and the name of its manufacturer. The driver and hardware information is added to lists of USB drivers and hardware communicable with the USB 12 like the ones in FIG. 4(a) and FIG. 4(b). These lists are stored as the USB driver information managing table 20 and the USB hardware information managing table 21 respectively in the storage section 19.

The obtained USB/IF driver/hardware information 8 is managed in association with the communications mode(s) in which the USB/IF is operable.

The external server 9 is, for example, a server owned by a hardware manufacturer, a PC manufacturer, or their representative which provides the USB/IF 12. A process will be detailed later whereby the printer device 1 obtains the latest driver/hardware information 8 to update the USB driver information managing table 20 and the USB hardware information managing table 21.

The correspondent USB driver/hardware information obtaining section 35 requests the host PC 2 to transmit the driver and hardware information of the USB/IF 22 to obtain the information.

The driver information identifies the driver and the name of its manufacturer. The hardware information identifies the hardware related to the device of the USB/IF 22 and the name of the manufacturer of the hardware. In other words, it is information which enables access to the information stored in the USB driver information managing table 20 and the USB hardware information managing table 21 in FIG. 4(a) and FIG. 4(b) respectively.

Settings are made in relation to the obtaining of the information so that the correspondent USB driver/hardware information obtaining section 35 automatically requests the host PC 2 to transmit the driver and hardware information of the USB/IF 22 when a connection is established between the printer device 1 and the host PC 2. In response to the request, the host PC 2 transmits the driver and hardware information of the USB/IF 22 to the printer device 1. The information is thus obtained by the correspondent USB driver/hardware information obtaining section 35.

The correspondent USB driver/hardware check section 36 checks the type of driver and hardware related to the USB/IF 22 and the transmission rate (communications mode) compatible with the USB/IF 22 on the basis of the driver and hardware information of the USB/IF 22 obtained by the correspondent USB driver/hardware information obtaining section 35.

The correspondent USB driver/hardware check section 36 compares the USB driver information managing table 20 and the USB hardware information managing table 21 in the storage section 19 with the driver and hardware information obtained from the host PC 2 to check the transmission rate (communications mode) which can be handled by the USB/IF 22 in the communications between the printer device 1 and the host PC 2.

The USB communications mode determining section 37 determines communications mode settings of the USB/IF 12 on the basis of the communications mode(s) in which the USB/IF 22 is operable that is checked out by the correspondent USB driver/hardware check section 36.

Next, as shown in FIG. 2, the host PC 2 includes, in the host PC USB notification control section 26, a host PC USB driver update section 39, a host PC driver/hardware information obtaining section 65, a host PC USB driver/hardware information transmit section 40, and a communications mode instructions section 64.

The host PC USB driver update section 39 obtains a latest USB driver 7 from the external server 9 over the communications network 4 to update the existing USB driver 38 stored in the storage section 28.

The host PC driver/hardware information obtaining section 65 obtains the latest driver and hardware information related to the USB/IF 22 from the external server 9 over the communications network 4. The host PC driver/hardware information obtaining section 65 will be detailed later in “Updating information on USB/IF 12 driver/hardware.”

As the host PC USB driver/hardware information transmit section 40 receives, from the printer device 1 to which the host PC 2 connects, a request to transmit information on the USB driver 38 for the USB/IF 22, the section 40 transmits the host PC USB driver/hardware information 58 stored in the storage section 28 to the printer device 1.

Upon receiving a user command from the operation/display section 27, the communications mode instructions section 64 gives communications mode instructions to the printer device 1 to which the host PC 2 connects over the printer cable 3 in the actual communications between the host PC 2 and the printer device 1.

Next will be described a process flow related to communications mode settings of the USB/IF 12 in the communications between the printer device 1 and the host PC in reference to FIG. 5.

First, the power supplies to the host PC 2 and the printer device 1 are turned on (step S1 and step S5; hereinafter, “S1,” “S5”).

The power supplies to the printer device 1 and the host PC 2 are both turned on, the host PC 2 and the printer device 1 performs a communications establishing process between them (S2, S6).

In step S2, step S6 (establishing of communications), the host PC 2 and the printer device 1 communicate with each other in full speed mode which is a communications mode compatible with the relatively old USB 1.1 standard. As mentioned above, the USB/IF 12 of the printer device 1 is compatible not only with the full speed mode defined in USB 1.1, but also with the high speed mode defined in USB 2.0 which is a higher-level standard than USB 1.1. Meanwhile, at the time of connection, it is unknown whether the USB/IF 22 of the host PC 2 to which the printer device 1 connects is compatible to high speed mode.

The communications establishing process will be detailed later.

After establishment of the communications between the host PC 2 and the printer device 1, the correspondent USB driver/hardware information obtaining section 35 in the printer device 1 requests the host PC 2 to transmit the driver and hardware information of the USB/IF 22 (S7).

As the host PC 2 receives the request, the host PC USB driver/hardware information transmit section 40 reads the host PC USB driver/hardware information 58 from the storage section 28 for a transmission to the printer device 1 (S3). In this manner, the host PC 2 notifies the printer device 1 of the driver and hardware information of the USB/IF 22.

Meanwhile, in the printer device 1, the correspondent USB driver/hardware information obtaining section 35 receives the host PC USB driver/hardware information 58 from the host PC 2 (S8). The correspondent USB driver/hardware information obtaining section 35 passes the host PC USB driver/hardware information 58 to the correspondent USB driver/hardware check section 36.

Next, the correspondent USB driver/hardware check section 36 checks the communications mode(s) in which the USB/IF 22 is operable in reference to the driver information managing table 20 and the hardware information managing table 21 in the storage section 19 on the basis of the obtained host PC USB driver/hardware information 58 (S9).

In other words, the correspondent USB driver/hardware check section 36 checks a list of the USB driver information in the driver information managing table 20 and a communications mode(s) compatible with the USB associated with that information on the basis of the driver information in the obtain host PC USB driver/hardware information 58. In addition, the correspondent USB driver/hardware check section 36 checks a list of the USB hardware information in the driver information managing table 20 and a communications mode(s) compatible with the USB associated with that information on the basis of the hardware information in the host PC USB driver/hardware information 58.

In this manner, the correspondent USB driver/hardware check section 36 checks the communications mode(s) in which the USB/IF 22 is operable.

Under these circumstances, if the correspondent USB driver/hardware check section 36 could check the communications mode(s) in which the USB/IF 22 is operable, and the USB/IF 22 turned out from the checking to be the compatible up to high speed mode (YES in S10), the information related to the communications mode(s) in which the USB/IF 22 is operable is transmitted to the USB communications mode determining section 37.

Meanwhile, if the correspondent USB driver/hardware check section 36 could not check the communications mode(s) in which the USB/IF 22 is operable or the USB/IF 22 is not compatible up to high speed mode (NO or full mode in S10), S11 through S14 (disconnection and other actions) are not implemented. Data is transferred in the original communications state.

The correspondent USB driver/hardware check section 36 can not check the communications mode(s) in which the USB/IF 22 is operable if the lists in the USB driver information managing table 20 and the USB hardware information managing table 21 contain no information which corresponds to the driver and hardware information of the USB/IF 22 obtained from the host PC 2.

Next, the USB communications mode determining section 37 determines the communications mode of the USB/IF 12 based on the information on the communications mode(s) in which the USB/IF 22 is operable which was transmitted from the correspondent USB driver/hardware check section 36. Here, the communications mode settings of the USB/IF 12 can be altered from full speed mode to high speed mode, the USB communications mode determining section 37 gives communications mode setting altering instructions to the USB communications control section 14.

Upon receiving the setting altering instructions, the USB communications control section 14 cuts the communications established between the host PC 2 and the printer device 1 (S1).

Based on the setting altering instructions from the USB communications mode determining section 37, the USB communications control section 14 makes such settings that the USB/IF 12 becomes compatible from default full speed mode to high speed mode (S12).

After the USB/IF 12 is set up to be compatible from full speed mode to high speed mode in this manner, the USB communications control section 14 again restarts communications with the host PC 2 (S13). A process is then performed to establish communications between the printer device 1 and the host PC 2 (S4, S14).

In the communications establishing process between the printer device 1 and the host PC 2, the host PC 2 designates the communications mode in which actual communications are done. That is, in step S12, the USB communications control section 14 set up the USB/IF 12 as a device compatible up to high speed mode; however, it depends on instructions from the host PC 2 in which communications mode data will be actual transferred. In addition, the communications establishing process in steps S4, S14 will be detailed later too.

The aforementioned processing step establishes communications between the host PC 2 and the printer device 1, enabling for example, image data to be transferred from the host PC 2 to the printer device 1 at, for example, a “high-speed-mode” transmission rate.

In other words, the printer system 100 in accordance with the present embodiment is configured so that the printer device 1 can check the communications mode(s) in which the USB/IF 22 is operable of the host PC 2 and decides communications mode settings for the USB/IF 12 of the printer device 1.

Therefore, if the USB/IF 22 of the host PC 2 is compatible up to high speed mode, the printer device 1 in the printer system 100 can switch the USB/IF 12 to communications mode settings compatible up to high speed mode to enable communications.

In addition, as mentioned above, the host PC 2 and the printer device 1 are configured so that in step S11, the host PC 2 and the printer device 1 cut communications, and the printer device 1 makes transmission rate settings, and then in step S13, reconnects to the host PC 2. Even if he communications mode settings with which the printer device 1 is operable are changed while the host PC 2 and the printer device 1 are communicating with each other, the host PC 2 cannot recognize changes in the communications mode settings unless the ID assigned to the printer device 1 upon connection is changed.

Therefore, the host PC 2 and the printer device 1 temporarily cut off the communications with each other and reconnect, so as to assign another ID to the printer device 1. In other words, the printer device 1 is assigned a different ID from the one assigned before the communications cutoff as if it was a printer device 1 set up to work in high speed mode, to enable the host PC 2 to communicate.

In this manner, the temporarily host PC 2 and the printer device 1 cut off communications and reconnect, so that the host PC 2 and the printer device 1 can communicate in the communications mode after the change.

Communications Establishing Process

As mentioned above, if in the communications mode setting process, the printer device 1 in accordance with the present embodiment carries out the communications establishing process with respect to the host PC 2 before others (step S6 in FIG. 5) and makes communications mode settings, the printer device 1 cuts off communications before carrying out a communications establishing process again (step S14 in FIG. 5).

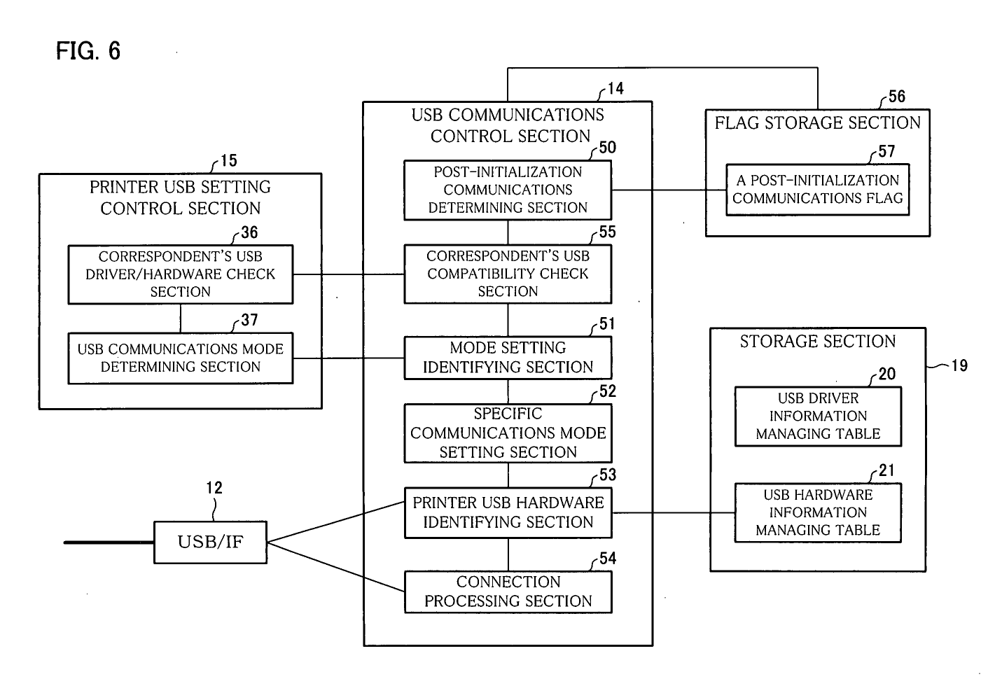

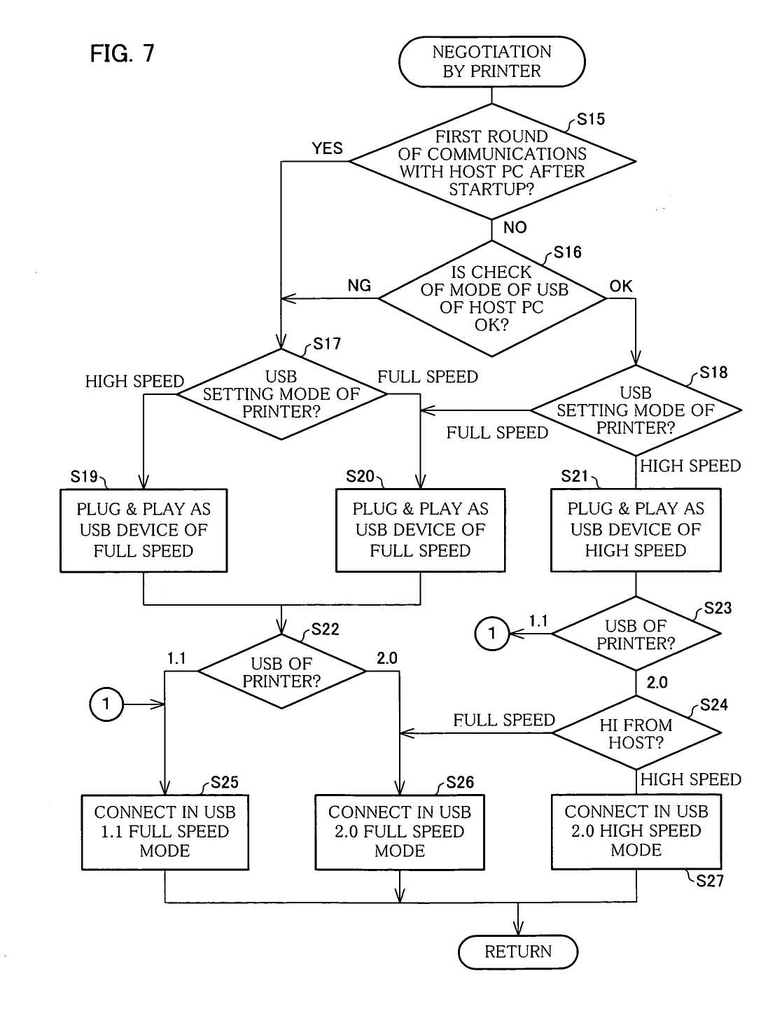

The following will describe these communications establishing processes carried out by the printer device 1 with respect to the host PC 2 in reference to FIG. 6 and FIG. 7.

FIG. 6 is a block diagram illustrating the configuration of the USB communications control section 14 in relation to the communications establishing process.

In the Figure, the correspondent USB driver/hardware information obtaining section 35 is omitted from the printer USB setting control section 15. In other words, FIG. 6 illustrates the configuration of the USB communications control section 14 in FIG. 1 in more detail. The figure illustrates only the detailed configuration of the USB communications control section 14 and other members related to the communications establishing process (S6, S14) whereby the printer device 1 establishes communications with the host PC 2 in the “communications mode settings of the USB/IF 12 of the printer device 1” in FIG. 5.

FIG. 7 is a flow chart illustrating, as an example, a communications establishing process implemented by the printer device 1 with respect to the host PC 2.

As shown in FIG. 6, the USB communications control section 14 includes an post-initialization communications determining section 50, a mode setting identifying section 51, a specific communications mode setting section 52, a printer USB hardware identifying section 53, a connection processing section 54, and a correspondent USB compatibility check section 55. In addition, the USB communications control section 14 is configured to raise a post-initialization communications flag 57 on a flag storage section 56 if the printer device 1 is powered on before communicating with the host PC 2. The flag storage section 56 is a RAM when a CPU and associated circuitry control the processing by the USB communications control section 14. It is a register when an IC and associated circuitry control the processing by the USB communications control section 14.

The post-initialization communications determining section 50 reads the post-initialization communications flag 57 to determine whether the printer device 1 communicates with the host PC 2 for the first time after a power-on.

The mode setting identifying section 51 finds out the current transmission rate setting, that is, communications mode, of the printer device 1.

The specific communications mode setting section 52 controls so that settings are altered to a predetermined communications mode based on the find by the mode setting identifying section 51 if the communications mode settings of the USB/IF 12 differ from the predetermined communications mode.

The printer USB hardware identifying section 53 finds out whether the USB/IF 12 hardware is compliant to the USB 1.1 or 2.0 standard. After the specific communications mode setting section 52 makes predetermined transmission rate settings, the printer USB hardware identifying section 53 obtains the model number of the USB/IF 12 from the USB/IF 12 so as to determine the USB/IF hardware standard in reference to the USB hardware information managing table 21 in the storage section 19.

The connection processing section 54 implements a connection process with respect to the host PC 2 in the communications mode set up by the specific communications mode setting section 52 in accordance with the standard of the USB/IF 12 of the printer device 1 identified by the printer USB hardware identifying section 53.

The correspondent USB compatibility check section 55 checks if the USB/IF 22 of the host PC 2 which is another party involved in the communications is compatible up to high speed mode.

Next will be described a process flow related to the printer device 1 establishing communications with the host PC 2 in reference to FIG. 7.

To carry out a communications establishing process with respect to the host PC 2, the printer device 1 first checks whether this is the first round of communications after a power-on of the printer device 1 (S15). In the case of step S6 in FIG. 5, communications are yet to be established between the printer device 1 and the host PC 2. Therefore, the process branches off to the “Yes” path in step S15.

In other words, when the printer device 1 receives a connection request from the host PC 2, the post-initialization communications determining section 50 refers to the post-initialization communications flag 56 to check whether this communications establishing process is the first round of communications after a power-on of the printer device 1. If the check determines that the communications process by the printer device 1 to the host PC 2 is the first after a start-up, the post-initialization communications determining section 50 instructs the mode setting identifying section 51 to identify the current communications mode setting of the printer device 1.

Next, based on the instructions from the post-initialization communications determining section 50, the mode setting identifying section 51 identifies the current communications mode setting of the printer device 1 (S17). The identifying is done by the mode setting identifying section 51 on the basis of communications mode setting instructions from the USB communications mode determining section 37 in the printer USB setting control section 15.

In the first communications establishing process after a start-up of the printer device 1, a communications mode is set up in advance. The USB communications mode determining section 37 decides settings of the USB/IF 12 in the setup communications mode.

If the mode setting identifying section 51 determines in step S17 that the USB/IF 12 is set up in a communications mode in advance which is compatible up to high speed mode (“HIGH SPEED” in S17), the specific communications mode setting section 52 implements a plug and play process with respect to the USB/IF 12 as a device of which the transmission rate can be made compatible up to full speed mode and make settings again with respect to the host PC 2 so as to be communicable at the transmission rate (S19).

In other words, in this case, the transmission rate of the USB/IF 12 of the printer device 1 is communicable up to high speed mode. The communications mode compatible with the hardware and driver of the USB/IF 22 of the host PC 2 with which the printer device 1 will communicate is however unknown at this time. Accordingly, the printer device 1 implements a plug and play process as full speed mode in which the transmission rate is backward compatible with conventional USB 1.1.

If the mode setting identifying section 51 determines in step S17 that the transmission rate is set in advance to full speed mode (“FULL SPEED” in S17), the specific communications mode setting section 52 implements a plug and play process with respect to the USB/IF 12 as a device of which the transmission rate is compatible up to full speed mode and make settings with respect to the host PC 2 so as to be communicable (S20) without changing the transmission rate.

Next, after the transmission rate setting in step S19 or step S20, It is determined whether the standard under which the USB/IF 12 of the printer device 1 is operable is 1.1 or 2.0 (S22). In other words, if the specific communications mode setting section 52 has completed the setting of the USB/IF 12 in a predetermined communications mode, the section 52 instructs the printer USB hardware identifying section 53 to identify the standard of the USB/IF 12. Upon receiving the instructions, the printer USB hardware identifying section 53 obtains the model number of the USB/IF 12 from the USB/IF 12 and refers to the USB hardware information managing table 21 to decide whether the standard of the USB/IF 12 is 1.1 or 2.0.

If it is decided as a result that the USB/IF 12 operates under USB 1.1, the connection processing section 54 carries out a connection process with respect to the host PC 2 on the basis of this decision and the aforementioned setting results of the specific communications mode setting section 52 (S25). In other words, the connection processing section 54 carries out a connection process with respect to the host PC 2 to communicate with the host PC 2 under the USB 1.1 standard at a transmission rate of full speed mode.

If the printer USB hardware identifying section 53 decides that the USB/IF 12 operates under USB 2.0, the connection processing section 54 carries out a connection process with respect to the host PC 2 to communicate with the host PC 2 under the USB 2.0 standard at a transmission rate of full speed mode (S26).

The first communications establishing process by the printer device 1 after a start-up, that is, step S6 in FIG. 5, implemented in this manner.

Next, will be described a communications establishing process after communications are cut off once to allow the printer device 1 to switch from current communications mode settings, that is, step S14 in FIG. 5.

First, similarly to the aforementioned process, if the printer device 1 implements a communications establishing process with the host PC 2, the printer device 1 checks whether this is the first round of communications after a power-on of the printer device 1 (S15).

This time, since the printer device 1 has previously established communications with the host PC 2 once, the post-initialization communications flag 57 is up (No in S15). In this case, the post-initialization communications determining section 50 instructs the correspondent USB compatibility check section 55 to check if the USB/IF 22 of the host PC 2 which is another party involved in the communications is compatible up to high speed mode.

Based on the instructions from the post-initialization communications determining section 50, the correspondent USB compatibility check section 55 obtains a check result by the correspondent USB driver/hardware check section 36 in the printer USB setting control section 15, to check whether the USB/IF 22 is compatible up to high speed mode (S16).

If the correspondent USB compatibility check section 55 decides in step S16 that the USB/IF 22 of the host PC 2 is compatible up to high speed mode, the section 55 instructs the mode setting identifying section 52 to identify how the communications mode of the printer device 1 is currently set up.

In this manner, the mode setting identifying section 51 receives instructions from the correspondent USB compatibility check section 55 and identify the current communications mode setting of the printer device 1 (S18). The identifying is done by the mode setting identifying section 51 in reference to results of the communications mode setting of the USB communications mode determining section 37 in the printer USB setting control section 15.

If the current mode setting identifying section 51 decides that the communications mode of the printer device is set up to be compatible up to high speed mode (high speed in S18), the specific communications mode setting section 52 implements a plug and play process with respect to the USB/IF 12 as a USB/IF of which the transmission rate is compatible up to high speed mode (S21).

In other words, in the case of the first establishing of communications from a power supply ON state, the specific communications mode setting section 52 implemented a plug and play process with respect to the USB/IF 12 as a USB/IF operable in full speed mode, regardless of the current communications mode setting of the printer device 1.

However, in the second and onward establishing of communications, since the USB communications mode determining section 37 decides a communications mode only after the correspondent USB driver/hardware check section 36 in the printer USB setting control section 15 checks information on the driver and hardware related to the USB/IF 22 of the host PC 2, the USB/IF 12 is set to the communications mode in accordance with the decision.

If the mode setting identifying section 51 determines in step S18 that the current communications mode setting of the printer device 1 is full speed mode, the operation proceeds to step S20. Description of the entailing steps in this case (S20, S22, S25 or S26) is omitted because the steps are identical to the communications establishing process in S6 in FIG. 5.

Next, after the transmission rate settings are made in step S21, it is determined whether the USB standard of the printer device 1 is 1.1 or 2.0 (S23). In other words, after the specific communications mode setting section 52 completes the set up of the USB/IF 12 in a communications mode compatible up to high speed mode, the section 52 instructs the printer USB hardware identifying section 53 to identify the standard of the USB/IF 12. Upon receiving the instructions, the printer USB hardware identifying section 53 obtains the model number of the USB/IF 12 from the USB/IF 12 and decides whether the standard of the USB/IF 12 is 1.1 or 2.0 in reference to the USB hardware information managing table 21.

If it is decided as a result that the USB/IF 12 operates under USB 1.1, the connection processing section 54 carries out a connection process with respect to the host PC 2 on the basis of this decision and the aforementioned setting results of the specific communications mode setting section 52 (S25). In other words, the connection processing section 54 carries out a connection process with respect to the host PC 2 to communicate with the host PC 2 under the USB 1.1 standard at a transmission rate of full speed mode.

If the printer USB hardware identifying section 53 decides that the USB/IF 12 operates under USB 2.0, and instructions are received from the host PC 2 to implement full speed mode, the connection processing section 54 carries out a connection process with respect to the host PC 2 to communicate with the host PC 2 under the USB 2.0 standard at a transmission rate of full speed mode (S26).

Meanwhile, if the printer USB hardware identifying section 53 decides that the USB/IF 12 operates under USB 2.0, and instructions are received from the host PC 2 to implement high speed mode, the connection processing section 54 carries out a connection process with respect to the host PC 2 to communicate with the host PC 2 under the USB 2.0 standard at a transmission rate of high speed mode (S27).

In other words, in the communications establishing process, the user of the host PC 2 designates a communications mode for the communications with the printer device 1 through, for example, the keyboard or other external input means on the operation/display section 27. Then, a command from the user is received by the communications mode instructions section 64 in the host PC USB notification control section 26. Receiving the command, the communications mode instructions section 64 sends instructions related to the communications mode designation from the user to the printer device 1 via the USB communications control section 25.

The instructions are received by the USB communications control section 14 in the printer device 1 and passed on to the USB communications mode determining section 37 in the printer USB setting control section 15. Upon receiving the communications mode designation instructions from the user, the USB communications mode determining section 37 instructs the USB communications control section 14 to perform communications in a communications mode in accordance with the user command.

These communications mode designation instructions from the USB communications mode determining section 37 are passed to the mode setting identifying section 51 in the USB communications control section 14. Then, the mode setting identifying section 51 identifies the instructions from the USB communications mode determining section 37 and checks communications mode settings. Then, results of the check is passed to the specific communications mode setting section 52. If the specific communications mode setting section 52 determines that the current communications mode differs from the previous one, the section 52 changes the communications mode settings on the basis of the results of the checking by the mode setting identifying section 51. If the section 52 determines that the current communications mode is identical to the previous one, the section 52 changes no communications mode settings.

Here, if the USB/IF 12 hardware is already checked as in step S24, the specific communications mode setting section 52 passes information on the post-setup communications mode to the connection processing section 54.

Then, the connection processing section 54 connects to the host PC 2 on the basis of the hardware standard of the USB/IF 12 as checked by the correspondent USB compatibility check section 55 and the communications mode as set up by the specific communications mode setting section 52.

(Driver/Hardware Information Update Process)

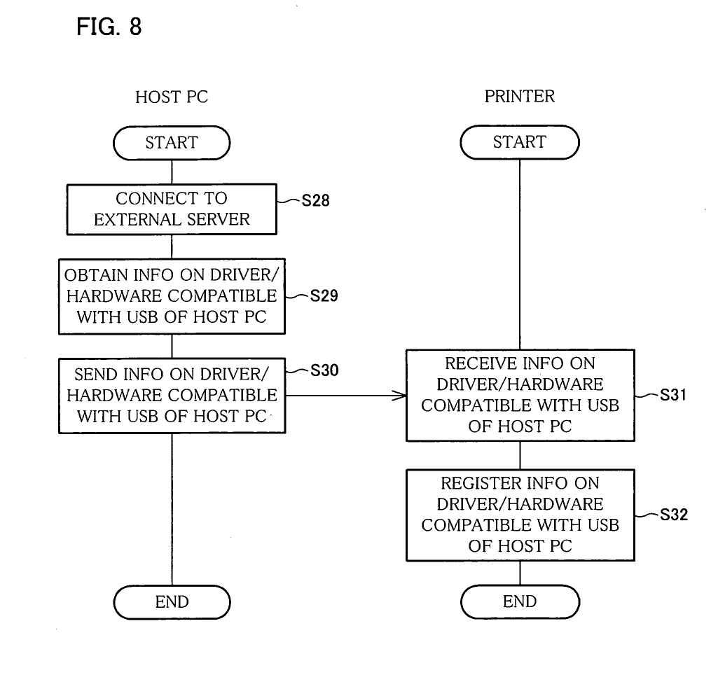

Next will be described a method of updating the lists of the USB driver information managing table 20 and the USB hardware information managing table 21 stored in the storage section 19 in the printer device 1 in reference to FIG. 8. FIG. 8 is a flow chart illustrating, as an example, a process updating the lists of the USB driver information managing table 20 and the USB hardware information managing table 21.

Assume that the printer device 1 is communicably connected to the host PC 2 as shown in FIG. 3.

The host PC 2 is adapted to communicate with the external server 9 via the communications network 4 over the network communications section 23. Accordingly, the user instructs the host PC 2 to obtain the latest driver and hardware information through, for example, the keyboard or other external input means on the operation/display section 27.

Receiving the user command, in the host PC 2, the network communications section 23 connects to the external server 9 (S28). If the host PC 2 successfully establishes a connection to the external server 9, the host PC driver/hardware information obtaining section 65 in the host PC 2 sends a request to the external server 9 for a transmission the latest host PC USB driver/hardware information 58. Upon receiving the transmission request from the host PC 2, the external server 9 transmits to the host PC 2 the latest driver and hardware information which corresponds to the USB/IF 22 of the host PC 2 from the driver/hardware information 8 stored in the external server 9. In this manner, the host PC 2 can obtain the latest driver/hardware information 58 (S29).

As the host PC 2 completes the obtaining of the latest driver and hardware information from the external server 9, the host PC driver/hardware information obtaining section 65 stores the information as the host PC USB driver/hardware information 58 in the storage section 28. Meanwhile, the host PC driver/hardware information obtaining section 65 instructs the host PC USB driver/hardware information transmit section 40 to transmit the obtained information to the printer device 1 connected to the host PC 1.

Thus instructed, the host PC USB driver/hardware information transmit section 40 transmits the latest driver and hardware information related to the USB/IF 22 to the printer device 1 (S30).

Meanwhile, the printer device 1 receives the latest driver and hardware information related to the USB/IF 22 of the host PC 2 from the host PC 2 (S31). In other words, the received information is obtained by the host PC driver/hardware information obtaining section 65 and appended to the lists of the USB driver information manage section 20 and the USB hardware information manage section 21 (S32). In this manner, the printer device 1 in accordance with the present embodiment can obtain the latest driver/hardware information on the host PC 2. Therefore, even if the USB/IF 22 of the host PC 2 is updated to the latest driver and hardware, the communications establishing process can handle.

The foregoing has described a process whereby the host PC 2 obtains driver and hardware information corresponding to the USB/IF 22 of the host PC 2. However, the printer device 1 may be set up to obtain the information direct from the external server 9.

In other words, the printer device 1 in accordance with the present embodiment includes the network communications section 11 as mentioned earlier, so as to communicate with the external server 9 provided outside via the communications network 4 in accordance with the instructions from the control section 6.

In addition, the printer device 1 includes the latest driver/hardware information obtaining section 63 in the printer USB setting control section 15 in the control section 6, so as to obtain the latest driver and hardware information 8 from the external server 9. Then, the latest driver/hardware information obtaining section 63 can append the obtained latest driver and hardware information to both the USB driver information managing table 20 and the USB hardware information managing table 21.

In this manner, the printer device 1 may be set up to by itself obtain the latest driver and hardware information. In such a case, setting may be made so that the information can be obtained at constant intervals as a trigger for the printer device 1 to obtain the latest driver and hardware information. In addition, a configuration may be made so that the information is obtained upon a user command through the operation/display section 18.

In addition, the host PC 2 in accordance with the present embodiment is configured to include the. host PC USB driver update section 39, so as to keep the driver of the USB/IF 22 updated.

As in the foregoing, the printer device 1 in accordance with the present embodiment can check the driver and hardware of the USB/IF 22 of the host PC 2 and set a suitable communications mode. In addition, even when the printer device 1 communicates with the host PC 2 for the first time, the printer device 1 can communicate with the host PC 2 in mutually communicable, full speed mode in a suitable manner regardless of the communications mode settings of the printer device 1.

Further, the printer device 1 can obtain the latest driver and hardware information stored in the external server 9; therefore, even if the driver of the USB/IF 22 of the host PC 2 is updated to the latest version, since information on this driver stored, the printer device 1 can communicate with the host PC 2 in a suitable communications mode.

Incidentally, very few multifunction printers (the printer device 1 is an example) and other like multifunction devices (composite devices) are compatible up to high speed mode under USB standards. For this reason, few USB/IFs compatible up to high speed mode are available to communicably connect the printer device 1 or like devices to the host PC 2.

Therefore, even if both the USB/IF 22 of the host PC 2 and the USB/IF 12 of the printer device 1 are compatible up to high speed mode, the host PC 2 set up to operate in high speed mode freezes when the host PC 2 connects to the printer device 1. Other problems are also possible. For example, the host PC 2 can successfully connects to the printer device 1, allowing the printer device 1 to function as a printer. Its scanner function however does not work.

Accordingly, as detailed in the present embodiment, the printer system where the printer device 1 which is a multifunction printer is connected to the host PC 2 is configured to check not only the transmission rate at which can the USB/IF 22 of the host PC 2 communicate, but also whether the USB/IF 22 is compatible with the printer device 1.

In other words, the printer device 1 in the configuration in FIG. 1 stores, in the USB driver information managing table 20, information as to whether the USB/IF drivers are compatible with the printer device 1 in addition to the information on the USB/IF drivers managed using the table. The printer device 1 also stores, in the USB hardware information managing table 21, information as to whether the USB/IF hardware is compatible with the printer device 1 in addition to the information on the USB/IF hardware managed using the table.

Whether the printer device 1 is compatible or not means whether the USB/IF of the device to which the printer device 1 will connect can or cannot actually establish communications with the printer device 1 at communicable transmission rates, that is, in a communications mode compatible up to high speed mode.

Therefore, for example, a USB/IF operable in up to high speed mode cannot communicate with the printer device 1 in high speed mode unless the USB/IF is compatible with the printer device 1. In cases of a USB/IF incompatible with the printer device 1 in this manner, communications are established in full speed communications mode supported by multifunction printers like the printer device 1.

Then, with the printer device 1 and the host PC 2 thus configured, in steps S7 to S10 shown in FIG. 5 of the aforementioned “communications mode settings of the USB/IF 12 of the printer device 1”, the following process is carried out. Description of steps S1 to S3, S5 to S8, and S4, S11 to S14 are omitted because the steps are identical to the “communications mode settings of the USB/IF of the printer device.”

In step S9, the correspondent USB driver/hardware check section 36 refers to the USB driver information managing table 20 and the USB hardware information managing table 21 on the basis of the obtained host PC USB driver/hardware information 58 to check if the USB/IF 22 of the host PC 2 is compatible with the multifunction printer device and compatible with high speed communications mode.

If the USB/IF 22 is compatible with both the printer device 1 and up to high speed communications mode (Yes in S10), the process continues at step S11 where communications are cut off.

Meanwhile, if the USB/IF 22 is incompatible with the printer device 1 and/or incompatible up to high speed communications mode (No in S10), step S11 and succeeding steps are not executed. Communications are done at original full speed mode.

If this “communications mode settings of the USB/IF 12 of the printer device 1” is done, in step S16 of a “communications establishing process”, the correspondent USB compatibility check section 55 obtains results of checks by the correspondent USB driver/hardware check section 36 to check whether the USB/IF 22 is compatible with both the multifunction printer and up to high speed mode as instructed by the post-initialization communications determining section 50.

Therefore, the printer device 1 in accordance with the present embodiment can prevent a problem that although the USB/IF 22 is compatible up to high speed mode, the communications between the printer device 1 and the host PC cannot be established in a suitable manner because the USB/IF 22 is incompatible with communications with the printer device 1 in high speed mode.

Embodiment 2

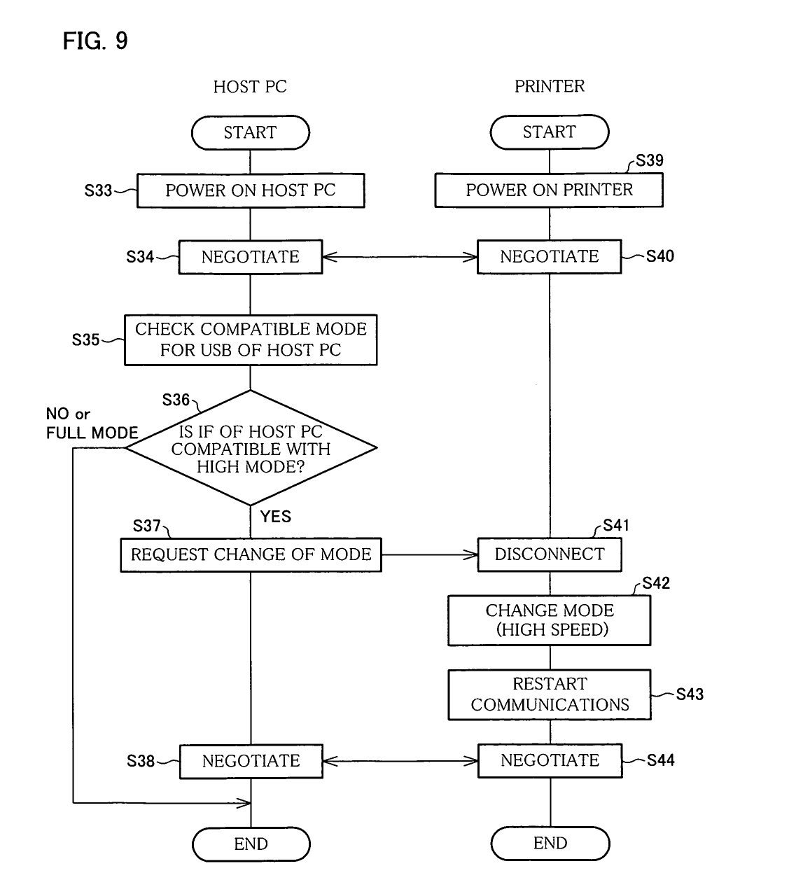

Referring to FIG. 9 through FIG. 12, the following will describe another embodiment of a communications mode setting altering process with respect to the USB/IF 12 between the printer device 1 and the host PC 2.

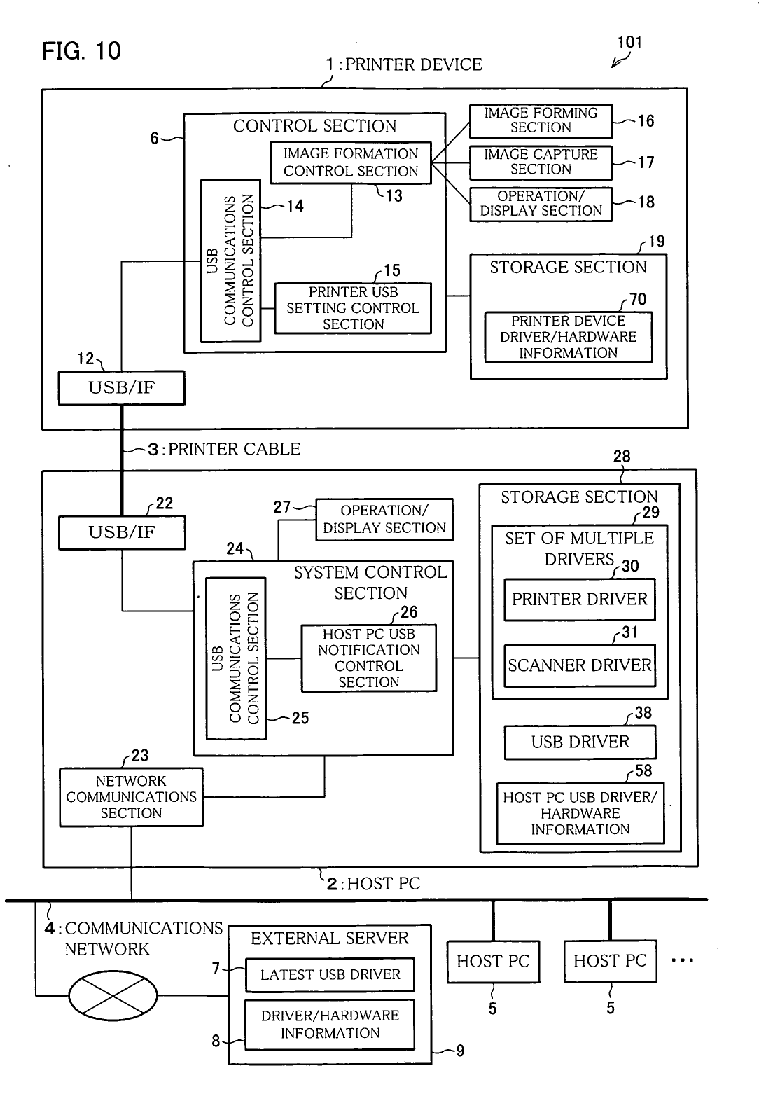

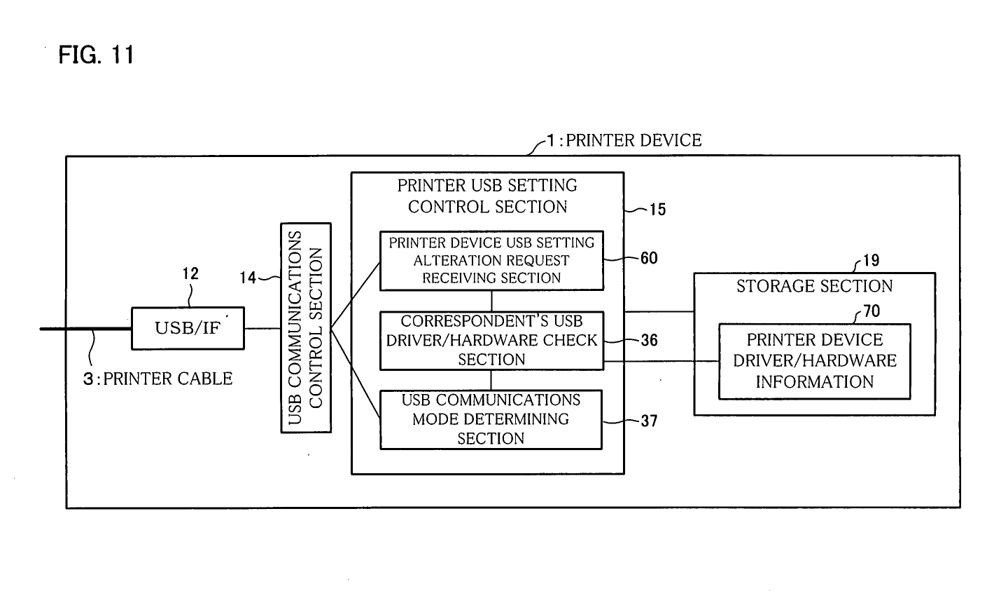

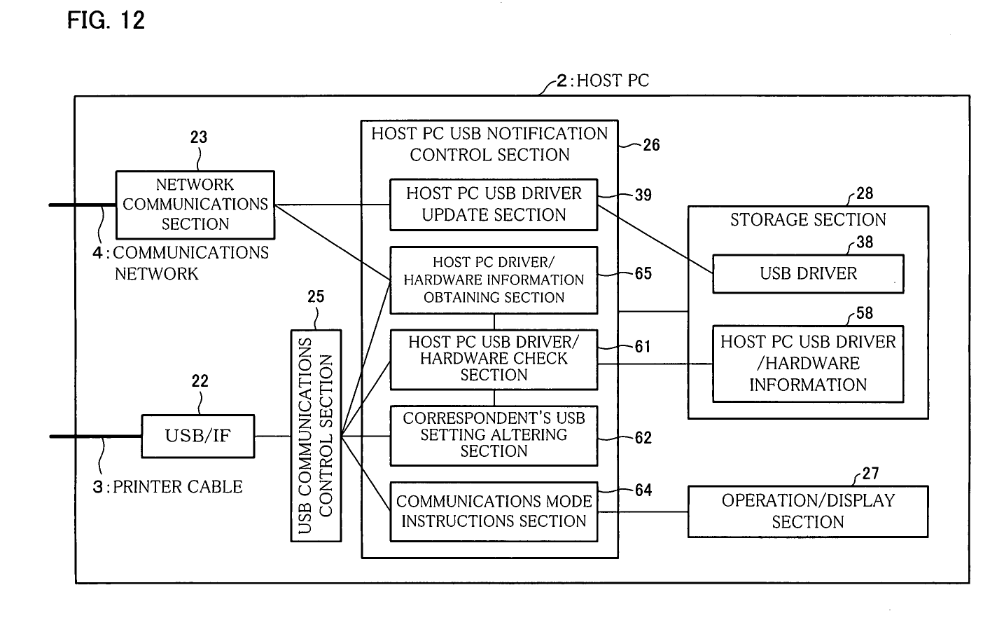

FIG. 9 is a flow chart illustrating a communications mode setting altering process with respect to the USB/IF 12 between the printer device 1 and the host PC 2. FIG. 10 illustrates, as an example, the configuration of a major part of a printer system 101 involving the printer device 1 and the host PC 2 in accordance with the present embodiment. FIG. 11 is a block diagram illustrating the configuration of a major part of the printer device 1 in relation to the communications mode setting altering process with respect to the USB/IF in accordance with the present embodiment. FIG. 12 is a block diagram illustrating the configuration of a major part of the host PC 2 in relation to the communications mode setting altering process with respect to the USB/IF in accordance with the present embodiment.

As shown in FIG. 10, in the printer system 101 in accordance with the present embodiment, the printer device 1 is lacking a network communications section 11. The system 101 thus differs from the aforementioned printer system 100 in that the former cannot communicate with the external server 9 or host PCs 5 provided outside over the communications network 4. In other words, although the printer device in the printer system 100 in FIG. 1 is configured to be communicable with the external host PC 2, host PC 5, and external server 9 via the network communications section 11 and the communications network 4, the printer device 1 in the printer system 101 is configured to be communicable only with the host PC 2 via the USB/IF 12 over the printer cable 3.

The printer device 1 in the printer system 101 is configured differently from the printer device 1 in the printer system 100 in that the former contains no network communications section 11 as mentioned above and that the storage section 19 stores no USB driver managing table 20 or USB hardware information managing table 21, but stores printer device USB driver/hardware information 70. In addition, the two printer devices 1 differ from each other in the functional blocks constituting the printer USB setting control section 15 (detailed later).

The printer device USB driver/hardware information 70 indicates the driver and hardware of the USB/IF 12 and the name of their manufacturers (for example, the title of the computer program and the model name of the hardware). The information 70 is also related to a communicable communications mode associated with the information.

Meanwhile, the host PC 2 in the printer system 101 has the same configuration as the host PC 2 in the printer system 100. The host PC 2 in the printer system 101, however, differs from the host PC 2 in the printer system 100 in the functional blocks constituting the host PC USB notification control section 26 (detailed later). In addition, the data stored in the storage section 28 which constitute the host PC USB driver/hardware information 58 is different. That is, in the host PC 2 in the printer system 100, the host PC USB driver/hardware information 58 is arranged from information related to the driver and hardware of the USB/IF 22.

However, in the host PC 2 in the printer system 101, the host PC USB driver/hardware information 58 is arranged from information related to the driver and hardware of the USB/IF 22 and information related to the communications mode of the USB/IF 22 associated with the information.

In other words, the printer system 100 is configured as follows: The driver and hardware information of the USB/IF of the host PC 2 is obtained by the printer device 1, and the USB/IF 22 checks the communicable communications mode in reference to the obtained information and the USB driver information managing table 20 and the USB hardware information managing table 21 stored in the storage section 19. Then, on the basis of results of the checking, the communications mode settings of the USB/IF 12 are decided.

Meanwhile, the printer system 101 is configured as follows: The host PC 2 checks the communications mode(s) in which the USB/IF 22 is operable and request for an alteration of the communications mode settings. In response to the request, the printer device 1 decides an alteration of the communications mode settings of the USB/IF 12.

Therefore, the following description will focus on differing structural members between the printer device 1 and the host PC 2 in accordance with the present embodiment and the printer device 1 and the host PC 2 in the printer system 100. Description of common structural members will be omitted.

Next will be described the configuration of the printer device 1 and the host PC 2 in a setup process of the USB/IF 12 of the printer device 1 and its process flow.

As shown in FIG. 11, the printer USB setting control section 15 in the printer device 1 includes a printer device USB setting alteration request receiving section 60, a correspondent USB driver/hardware check section 36, and a USB communications mode determining section 37.

In other words, differences from the printer USB setting control section 15 in the printer device 1 in the printer system 100 lie where the latest driver/hardware information obtaining section 63 is missing and the printer device USB setting alteration request receiving section 60 replaces the correspondent USB driver/hardware information obtaining section 35.

The printer device USB setting alteration request receiving section 60 receives a request for an alteration of the communications mode settings of the USB/IF 12 from the host PC 2. Then, the print device USB setting alteration request receiving section 60 passes the request for an alteration of the settings to the correspondent USB driver/hardware check section 36. The printer device USB setting alteration request receiving section 60 is configured to, if the USB/IF 12 is incompatible with the communications mode requested by the host PC 2. return to the host PC 2 a signal indicating that the section 60 cannot accept the request for an alteration of the settings.

Upon receiving information related to the request for an alteration of the settings by the host PC 2 from the printer device USB setting alteration receiving section 60, the correspondent USB driver/hardware check section 36 refers to this information and the printer device USB driver/hardware information 70 to check whether the communications mode settings of the USB/IF 12 can be altered to the communications mode requested by the host PC 2.

If as a result of the checking, the communications mode cannot be altered to the settings for the communications mode requested by the host PC 2, a signal indicating that is sent to the printer device USB setting alteration request receiving section 60.

Meanwhile, as shown in FIG. 12, the host PC USB notification control section 26 in the host PC 2 in accordance with the present embodiment includes a host PC USB driver update section 39, a host PC driver/hardware information obtaining section 65, a host PC USB driver/hardware check section 61,a correspondent USB setting alteration request section 62, and a communications mode instructions section 64.

In other words, when compared with the host PC USB notification control section 26 in the host PC 2 in the printer system 100, the host PC USB notification control section 26 is lacking the host PC USB driver/hardware information transmit section 40. and different from the host PC 2 in the printer system 100 in that it instead includes the host PC USB driver/hardware check section 61 and the correspondent USB setting alteration request section 62.

The host PC USB driver/hardware check section 61 refers to host PC USB driver/hardware information 58 stored in the storage section 28 to check the communications mode(s) in which the host PC 2 is operable. As the first round of communications is established between the host PC 2 and the printer device 1 after a start-up of the power supplies for the host PC 2 and the printer device 1, the printer device USB driver/hardware check section 60 checks the communications mode(s). Then, the printer device USB driver/hardware check section 60 passes the results of the checking to the correspondent USB setting alteration request section 62.

If the correspondent USB setting alteration request section 62 determines from the results of the checking by the host PC USB driver/hardware check section 61 that the USB/IF 22 is compatible with a mode in which the transmission rate is faster than in the current communications mode, the section 62 requests the printer device 1 to alter the communications mode settings of the USB/IF 12 in the current communications.

Next will be described a setting altering process with respect to the USB/IF 12 of the printer device 1 in reference to FIG. 9 and also structural members constituting the aforementioned printer USB setting control section 15 and host PC USB notification control section 26 in detail.

As shown in FIG. 9, first, the host PC 2 and the printer device 1 are powered on (S33, S39). Then, as the host PC 2 and the printer device 1 are both powered on, a communications establishing process is implemented between the two devices (S34, S40). This communications establishing process was detailed in relation to the “first round of communications establishing process.” The process is identical to the process in step S6 shown in FIG. 5, and description will be omitted. Note however that in step S22 shown in FIG. 7, the printer device 1, in the process step where it is checked if the standard of the USB/IF 12 of the printer device 1 is 1.1 or 2.0, differs from the printer device 1 in the printer system 100 in that the printer USB hardware identifying section 53 refers to the printer device USB driver/hardware information 70 for checking. This round of communications is done in full speed mode as mentioned above.

As communications are established between the host PC 2 and the printer device 1, the host PC 2 checks the communications mode(s) in which the USB/IF 22 of the host PC 2 is operable (S35). In other words, as the host PC USB driver/hardware check section 61 is notified from the USB communications control section 25 that communications have been established, the section 61 refers to the host PC USB driver/hardware information 58 stored in the storage section 28 to check the communications mode(s) in which the USB/IF 22 is operable. Then, the host PC USB driver/hardware check section 61 sends results of this checking to the correspondent USB setting alteration request section 62.

If the host PC USB driver/hardware check section 61 can check the communications mode(s) in which the USB/IF 22 is operable, and the USB/IF 22 is compatible up to high speed mode (YES in S36), the correspondent USB setting alteration request section 62 requests the printer device 1 to alter the communications mode to high speed mode (S37).

If regarding the host PC USB driver/hardware check section 61, the USB/IF 22 is not compatible up to high speed mode (NO or full mode in S36), the communications continue in full speed mode without an alteration.

Meanwhile, in the printer device 1, the printer device USB setting alteration request receiving section 60 receives information related to the communications mode(s) in which the USB/IF 22 is operable from the correspondent USB setting alteration request section 62 in the host PC 2 and passes information related to a request of an alteration of the communications mode settings from the host PC 2 to the correspondent USB driver/hardware check section 36.

Then, the correspondent USB driver/hardware check section 36 refers to the printer device USB driver/hardware information 70 to check the communications mode(s) in which the USB/IF 12 is operable, and determines whether the settings can be altered to high speed mode as requested by the host PC 2.

If as a result of the determining, the communications mode of the USB/IF 12 cannot be altered to the communications mode requested by the host PC 2, the correspondent USB driver/hardware check section 36 sends a signal indicating that to the printer device USB setting alteration request receiving section 60. As the printer device USB setting alteration request receiving section 60 receives the signal, the printer device USB setting alteration request receiving section 60 sends, to the host PC 2, information that the section 60 failed to accept the request to alter the communications mode settings. In this manner, if the request to alter the communications mode settings is refused, the host PC 2 maintains the communications mode of the USB/IF 22 in full speed mode.

If the communications mode of the USB/IF 12 can be altered to the communications mode as requested by the host PC 2, the USB communications control section 14 is instructed to cut off the communications between the host PC 2 and the printer device 1 via the printer device USB setting alteration request receiving section 60 (S41). Meanwhile, the correspondent USB driver/hardware check section 36 sends the content of the request to alter the communications mode settings of the USB/IF 12 from the host PC 2 to the USB communications mode determining section 37.

Incidentally, the correspondent USB driver/hardware check section 36 does not need to check the driver and hardware information of the USB/IF 22 as with the correspondent USB driver/hardware check section 36 in the printer device 1 in the printer system 100.

This is because the communications mode(s) in which the USB/IF 22 is operable is already checked by the host PC 2. Therefore, the correspondent USB driver/hardware check section 36 checks to which communications mode the host PC 2 requests an alteration of the settings and passes results of the checking to the USB communications mode determining section 37.

Next, as the USB communications mode determining section 37 receives the results of the checking from the correspondent USB driver/hardware check section 36, the USB communications mode determining section 37 determines an alteration of the settings in accordance with the results of the checking so that the communications mode settings of the USB/IF 12 is compatible up to high speed mode (S42).

In other words, the printer device USB setting alteration request receiving section 60 checks the received request for an alternation of the communications mode settings in the correspondent USB driver/hardware check section 36, results of the checking are received by the USB communications mode determining section 37. Then, the USB communications mode determining section 37 instructs the USB communications control section 14 to alter the settings in accordance with results of the checking so that the communications mode settings of the USB/IF 12 is compatible up to high speed mode.

Then, as the USB communications control section 12 receives the instructions, the section 12 again restarts communications with the host PC 2 (S43). A communications establishing process is implemented between the printer device 1 and the host PC 2 (S38, S44).

The communications establishing process is executed by the “communications establishing process after a communications cutoff” in the printer device 1 in the printer system 100, that is, a processing step identical to step S14 in FIG. 5, and description is omitted.

Note however that in step S22 shown in FIG. 7, the printer device 1, in the processing step where it is checked if the standard of the USB/IF 12 of the printer device 1 is 1.1 or 2.0, differs from the printer device 1 in the printer system 100 in that the printer USB hardware identifying section 53 refers to the printer device USB driver/hardware information 70 for checking.

As mentioned earlier, the printer system 101 in accordance with the present embodiment is configured, unlike the foregoing embodiment, so that the host PC 2 can make a request to alter the communications mode settings to the USB/IF 12. Therefore, the printer device 1 can alter the communications mode settings of the USB/IF 12 to communicate with the host PC 2 in accordance with the communications mode setting altering instructions from the host PC 2.

In addition, the host PC 2 includes the network communications section 23; therefore, the host PC 2 can obtain the latest driver for the USB/IF 22 and the driver information and hardware information with respect to the driver from the external server 9. Therefore, the host PC 2 can update the driver of the USB/IF 22 to the latest version. Therefore, even if, for example, the host PC 2 was compatible up to full speed communications mode before the update of the USB/IF 22 driver, the update renders the host PC 2 compatible up to high speed mode.

Incidentally, the aforementioned problems occur also in the printer system 101 in accordance with the present embodiment. Even if both the USB/IF 22 of the host PC 2 and the USB/IF 12 of the printer device 1 are compatible up to high speed mode, the host PC 2 freezes or the scanner function of the printer device 1 does not work, unless the USB/IF 22 is compatible with the printer device 1.

Accordingly, in the printer system where the printer device 1 which is a multifunction printer is connected to the host PC 2, it is preferable if the host PC 2 is configured to check not only the transmission rate at which can the USB/IF 22 communicable, but also whether the USB/IF 22 is compatible with the printer device 1.

In other words, in the set of multiple drivers 29 shown in FIG. 10, the host PC 2 further stores a USB/IF-compatibility list (not shown) constituted by multiple pieces of information as to whether the USB/IF is compatible the a multifunction printer like the printer device 1.

Whether the USB/IF is compatible with the printer device 1 or not means whether the USB/IF of the device to which the printer device 1 will connect can or cannot actually establish communications with the printer device 1 at communicable transmission rates. For example, a USB/IF of a device to which the printer device 1 will connect is communications up to high speed mode cannot communicate with the printer device 1 in high speed mode unless the USB/IF is compatible with the printer device 1. In cases of a USB/IF incompatible with the printer device 1 in this manner, communications are established in full speed communications mode supported by multifunction printers like the printer device 1.

Now will be described the “setting altering process for the USB/IF 12 of the printer device 1” in accordance with the present embodiment in reference to FIG. 9. Steps other than steps S35 to S37 are identical to the above-described “setting altering process for the USB/IF 12 of the printer device 1,” and description is omitted.

In step S35 in FIG. 9, the host PC USB driver/hardware check section 61 refers to the host PC USB driver/hardware information 58 and the USB/IF-compatibility list which is stored in the set of multiple drivers 29, to check whether the USB/IF 22 is compatible with the multifunction printer and the communications mode(s) in which the USB/IF 22 is operable.

In other words, the host PC USB driver/hardware check section 61 checks the communications mode(s) under which the USB/IF 22 is communicable, from the driver and hardware information of the USB/IF 22 stored in the host PC USB driver/hardware information 58. Further, the host PC USB driver/hardware check section 61 compares the host PC USB driver/hardware information 58 with the USB/IF-compatibility list, to check information as to whether the USB/IF 22 is compatible with the multifunction printer.

Then, the host PC USB driver/hardware check section 61 sends results of the checking to the correspondent USB setting alteration request section 62.

In foregoing step S36, the host PC USB driver/hardware check section 61 has checked out that the USB/IF 22 is compatible with up to high speed mode and corresponds to a multifunction printer (YES in S36), the correspondent USB setting alteration request section 62 requests the printer device 1 to alter communications mode to high speed mode (S37).

Meanwhile, if the USB/IF 22 is not compatible up to high speed mode and/or the USB/IF 22 does not correspond to the printer device 1 (No or full mode in S36), the host PC USB driver/hardware check section 61 does not request the printer device 1 to alter communications mode and continues to operate in full speed mode.

In this manner, the host PC 2 in accordance with the present embodiment is configured checks whether the USB/IF 22 in the host PC 2 is compatible up to high speed mode and corresponds to a multifunction printer device before requesting the printer device 1 to alter communications mode.

Therefore, the problem that communications between the printer device 1 and the host PC 2 are not established in a suitable manner when the USB/IF 22 is compatible up to high speed mode, but not with the printer device 1 is prevented from occurring.

(Configuration Providing Functional Blocks)

Next will be described a configuration which realizes functional blocks for the printer device 1 and the host PC 2 in the printer systems 100, 101.

The printer device 1 is equipped with the control section 6 which contains various functional blocks. These functional blocks are realized by, for example, a CPU (central processing unit) or other computing means executing program code contained in a ROM (read only memory), RAM (random access memory), or other storage medium. In addition, the storage section 16 in the printer device 1 is be realized by, for example, a flash EEPROM or other non-volatile storage medium.

The printer 7 is equipped with the USB communications control section 14 which contains functional blocks. These functional blocks are realized by, for example, a CPU or other computing means executing program code contained in a ROM, RAM, or other storage medium.

The description above took as an example cases where the functional blocks are realized by a CPU or other computing means executing program code contained in a ROM, RAM, or other storage medium. Alternatively, the function blocks may be realized by hardware carrying out the same processes. A further alternative is a combination of hardware carrying out some of the processes and computing means controlling the hardware and executing program code for the other processes. Further, those members which were described as hardware may be realized by a combination of hardware carrying out some of the processes and computing means controlling the hardware and executing program code for the other processes. The computing means may be a single entity, or a set of computing means connected over internal device bus and various communications paths may work together to execute program code.

The program code itself directly executable by the computing means or the program as data that can generate program code by decompression or an other process (detailed later) is executed by the computing means after the program (program code or the data) is recorded and distributed on a storage medium or the program is transmitted and distributed over communications means which transmits the program over wired or wireless communications paths.

To transmit over a communications path, a program is transmitted though the communications path by means of a series of signals indicative of a program which propagate through the transmission media constituting the communications path. To transmit a series of signals, a transmitter device may modulate a carrier wave with the series of signals indicative of the program to transmit the series of signals on the carrier wave. In this case, a receiver device will restore the series of signals by demodulating the carrier wave. Meanwhile, when transmitting the series of signals, the transmitter device may divides the series of signals as a series of digital data into packets for a transmission. In this case, the receiver device will combine received group of packets to restore the series of signals. In addition, the transmitter device may transmit the series of signals by time division, frequency division, code division, or another multiplex scheme involving the series of signals and another series of signals. When this is the case, the receiver device will extract individual series of signals from a multiplex series of signals to restore them. In any case, similar effects are obtained if the program can be transmitted over a communications path.

Here, the storage medium for the distribution of a program is preferable removable. After the distribution of the program, the storage medium may or may not be removable. In addition, the storage medium may or may not be rewriteable (writeable) or volatile, be recordable by any method, and come in any shape at all, provided that the medium can hold the program. Examples of such a storage medium include tapes, such as magnetism tapes and cassette tapes; magnetic disks, such as floppy (registered trademark) disks and hard disks; and other discs, such as CD-ROMs, magneto-optical discs (MOs), mini discs (MDs), and digital video discs (DVDs). In addition, the storage medium may be a card, such as an IC card or an optical card; a semiconductor memory, such as a mask ROM, an EPROM, an EEPROM, or a flash ROM; or a memory provided inside a CPU or other computing means.

The program code may be such that it instructs the computing means regarding all the procedures of the processes. If there is already a basic computer program (for example, an operating system or library) which can be retrieved by a predetermined procedure to execute all or some of the processes, code or a pointer which instructs the computing means to retrieve that basic computer program can replace all or some of the processes.

In addition, the program storage format of the storage medium may be, for example, such that: the computing means can access the program for an execution as in an actual memory having loaded the program; the program is not loaded into an actual memory, but installed in a local storage medium (for example, an actual memory or hard disk) always accessible to the computing means; or the program is stored before installing in a local storage medium from a network or a mobile storage medium. In addition, the program is not limited to compiled object code. The program may be stored as source code or intermediate code generated in the course of interpretation or compilation. In any case, similar effects are obtained regardless of the format in which the storage medium stores the program, provided that decompression of compressed information, decoding of encoded information, interpretation, compilation, links, or loading to an memory or combinations of these processes can convert into a format executable by the computing means.

The foregoing has described the printer systems 100, 101 in which the printer device 1 is communicably connected to the host PC 2. Other devices may be connected to each other. For example, the host PC 2 may be connected to another host PC via a USB or other communications IF.

In addition, in the printer system 100, the correspondent USB driver/hardware check section 37 checks the capability related to the transmission rate(s) at which the USB/IF 22 in the host PC 2 can communicate in reference to the USB driver information managing table 20 and the USB hardware information managing table 21. However, the correspondent USB driver/hardware check section 37 may be configured to check the capability related to the transmission rate(s) at which the USB/IF 22 can communicate in reference to either one of the USB driver information managing table 20 and the USB hardware information managing table 21.

In addition, as mentioned above, the printer system 100 or 101 in accordance with the present invention has so far been assumed to be configured so that the printer device 1 alters the communications mode settings of the communications IF of the printer device 1. This is not the only possibility. Conversely, the system 100 or 101 may be configured so that the communications mode settings for the communications IF of the host PC 2 may be altered in accordance with the communications mode(s) compatible with the communications IF of the printer device 1.

In addition, the present invention is applicable to systems configured so that two or more information processing devices are communicably connected with each other via a communications IF. The present invention is applicable not only to USB/IFs or like communications IFs, but also to other communications IFs, such as SCSI interfaces, where different communications mode are defined, because the driver and hardware information of the communications IF of another party involved in the communications is checked and communications are carried out in a compatible communications mode to the other party involved in the communications.

An information processing device the present invention is an information processing device communicably connected to another information processing device and includes: a communications interface list storage section for storing a communications interface information list recording a relationship between multiple sets of communications interface information which are information related to a driver and/or hardware of a communications interface and a communicable transmission rate; a correspondent communications interface information obtaining section for requesting and obtaining correspondent communications interface information which is communications interface information on a communications interface of the other information processing device from the other information processing device; a correspondent communications capability check section for checking a communicable transmission rate of the communications interface of the other information processing device in reference to the correspondent communications interface information and the communications interface information list; and a transmission rate determine section for determining a setting related to a transmission rate of a communications interface of the information processing device in accordance with a result of the checking by the correspondent communications capability check section.

In addition, the information processing device in accordance with the present invention, in the foregoing configuration, may be such that the communicable transmission rate on the communications interface list is a communicable transmission rate with respect to the information processing device.

A communicable transmission rate with respect to the information processing device refers not only to respective transmission rates at which the information processing device and another information processing device communicably connected to the information processing device can perform communications, but to a transmission rate at which the information processing device and the other information processing device can actually communicate with each other.

Therefore, the information processing device can be set to such a transmission rate of a communications interface that the device can certainly communicate with the other information processing device.

In addition, the information processing device in accordance with the present invention, in the foregoing configuration, may be configured to further include a communications interface information list update section for obtaining the communications interface information from an external server and updating the communications interface information list.

Therefore, even in cases where the driver and/or hardware of the communications interface of the other information processing device are not registered in the existing communications interface information list, the information processing device can obtain that information from an external server through the communications interface information update section.

Therefore, in the information processing device, the communications interface performance check section checks the capabilities related to the transmission rate of the communications interface of the other information processing device in reference to the updated communications interface information list, and the transmission rate determine section decides a transmission rate for the information processing device based on a result of the checking.

A case where the communications interface of the other information processing device is not registered in the existing communications interface information list refers to, for example, a case where the communications interface of the other information processing device is a latest driver and/or hardware.

In addition, the information processing device in accordance with the present invention is an information processing device communicably connected to another information processing device and includes: an information processing device communications interface information storage section for storing information processing device communications interface information representing a relationship between communications interface information which is information related to a driver and/or hardware of a communications interface with respect to the information processing device and a communicable transmission rate; an information processing device communications interface check section for checking a transmission rate of a communications interface of the information processing device on the basis of communications interface information of the information processing device; and a transmission rate setting alteration request section for requesting the other information processing device to alter a transmission rate setting of a communications interface of the other information processing device in accordance with a result of the checking by the information processing device communications interface check section.

In addition, the information processing device in accordance with the present invention, in the foregoing configuration, may be configured to further comprising a device driver controlling the other information processing device, wherein: the device driver stores a correspondent compatibility information list representing a relationship between the sets of communications interface information and a communicable transmission rate with respect to the other information processing device; and the information processing device communications interface check section checks a transmission rate at which the communications interface of the information processing device can communicate with the other information processing device on the basis of the information processing device communications interface information and the correspondent compatibility information list.

A communicable transmission rate with respect to the other information processing device refers to not only to respective transmission rates at which the information processing device and another information processing device communicably connected to the information processing device can perform communications, but to a transmission rate at which the information processing device and the other information processing device can actually communicate with each other.

Therefore, the information processing device can certainly check a communicable transmission rate with respect to the other information processing device and give instructions to the other information processing device to alter a transmission rate setting.

In addition, the information processing device in accordance with the present invention, in the foregoing configuration, may be configured to further include an information processing device communications interface information obtaining section for obtaining the communications interface information of the information processing device from the external server for storage in the information processing device communications interface information storage section.

Therefore, if the communications interface information related to the communications interface of the information processing device is not stored, the provision of the information processing device communications interface information obtaining section enables the information processing device to obtain the communications interface information of the communications interface of the information processing device from the external server.

Therefore, the information processing device can reliably notify the other information processing device of the communications interface information of the communications interface of the information processing device or the transmission rate capability with which the communications interface can operate.

In addition, the information processing device in accordance with the present invention, in the foregoing configuration, may be configured to further include a communications interface information transmit section for obtaining the communications interface information from an external server storing the communications interface information for a transmission to the other information processing device.

Therefore, even if the other information processing device cannot connect to an external server, the other information processing device can update the communications interface information list stored in the information processing device by the information processing device transmits the communications interface information to the other information processing device.

An external server refers to, for example, a server owned by a hardware manufacturer, a PC manufacturer, or their representative which provides the communications interface.

The information processing system in accordance with the present invention is an information processing system configured so that an information processing device is communicably connected to another information processing device, wherein: the information processing device includes: a communications interface list storage section for storing a communications interface information list recording a relationship between multiple sets of communications interface information which are information related to a driver and/or hardware of a communications interface and a communicable transmission rate; a correspondent communications interface information obtaining section for requesting and obtaining correspondent communications interface information which is communications interface information on a communications interface of the other information processing device from the other information processing device; a correspondent communications capability check section for checking a transmission rate capability of the communications interface of the other information processing device in reference to the correspondent communications interface information and the communications interface information list; and a transmission rate determine section for determining a setting related to a transmission rate of a communications interface of the information processing device in accordance with a result of the checking by the correspondent communications capability check section, and the other information processing device includes: an information processing device communications interface information storage section for storing information processing device communications interface information which is communications interface information of the other information processing device; and an information processing device communications interface information transmit section for transmitting the information processing device communications interface information in accordance with a request from the information processing device.

Therefore, in the information processing system, the information processing device can obtain communications interface information of the other information processing device to check the transmission rate capability with which the communications interface of the other information processing device can operate and decide a transmission rate of a communications interface for the information processing device.

Therefore, according to the information processing system, even if in the communications between the information processing device and the other information processing device, the transmission rate capabilities of the communications interfaces of the devices differ from each other, communications in accordance with the transmission rate capability of a communications interface of the other information processing device becomes possible.

The information processing system in accordance with the present invention is an information processing system configured so that an information processing device is communicably connected to another information processing device, wherein: the information processing device includes: an information processing device communications interface information storage section for storing information processing device communications interface information which is information related to a driver and/or hardware of a communications interface with respect to the information processing device; an information processing device communications interface check section for checking a communicable transmission rate of the communications interface of the information processing device on the basis of the communications interface information of the information processing device; and a transmission rate setting alteration request section for requesting the other information processing device to alter a transmission rate setting of a communications interface of the other information processing device in accordance with a result of the checking by the information processing device communications interface check section, and the other information processing device includes: a setting alteration request receiving section for receiving a request from the information processing device to alter in relation to the transmission rate setting of the communications interface of the other information processing device; and a transmission rate determine section for determining the transmission rate setting of the communications interface of the other information processing device in accordance with the received setting alteration request.

Therefore, in the information processing system, the information processing device can check the communicable transmission rate of the information processing device on the basis of the information processing device communications interface information. Then, on the basis of a result of the checking, the information processing device can request the other information processing device to alter, the transmission rate setting of the communications interface of the other information processing device. Meanwhile, the other information processing device can alter the transmission rate setting of the communications interface of the information processing device on the basis of the request.

Therefore, according to the information processing system, even if in the communications between the information processing device and the other information processing device, the communicable transmission rates of the communications interfaces of the devices differ from each other, communications in accordance with the communicable transmission rate of the communications interface of the other information processing device becomes possible.

The transmission rate setting method in accordance with the present invention is a transmission rate setting method for an information processing device communicably connected to another information processing device, the information processing device storing a communications interface information list recording a relationship between multiple sets of communications interface information which are information related to a driver and/or hardware of a communications interface and a communicable rate, the method including: the correspondent communications interface information obtain step of obtaining correspondent communications interface information which is communications interface information of the other information processing device from the other information processing device; the communications interface capability check step of comparing the correspondent communications interface information with the communications interface information list to check a transmission rate of the communications interface of the other information processing device; and the transmission rate decide step of deciding a transmission rate of a communications interface of the information processing device in accordance with a result of checking in the communications interface capability check step.

Therefore, according to the transmission rate setting method, even if in the communications between the information processing device and the other information processing device, the communicable transmission rates of the communications interfaces of the devices differ from each other, communications in accordance with the transmission rate of the communications interface of the other information processing device becomes possible.

The information processing device may be realized by a computer. When this is the case, the scope of the present invention encompasses a control program runs the computer as the aforementioned sections so that the information processing device can be realized by the computer and contain computer-readable storage medium containing the control program.

The embodiments and examples described above are for illustrative purposes only and by no means limit the scope of the present invention. Variations are not to be regarded as a departure from the spirit and scope of the invention, and all such modifications as would be obvious to one skilled in the art are intended to be included within the scope of the claims below.

1. An information processing device communicably connected to another information processing device, comprising:
a communications interface list storage section for storing a communications interface information list recording a relationship between multiple sets of communications interface information which are information related to a driver and/or hardware of a communications interface and a communicable transmission rate;
a correspondent communications interface information obtaining section for requesting and obtaining correspondent communications interface information which is communications interface information on a communications interface of the other information processing device from the other information processing device;
a correspondent communications capability check section for checking a communicable transmission rate of the communications interface of the other information processing device in reference to the correspondent communications interface information and the communications interface information list; and
a transmission rate determine section for determining a setting related to a transmission rate of a communications interface of the information processing device in accordance with a result of the checking by the correspondent communications capability check section.

2. The information processing device as set forth in claim 1, wherein the communicable transmission rate on the communications interface list is a communicable transmission rate with respect to the information processing device.

3. The information processing device as set forth in claim 1, further comprising a communications interface information list update section for obtaining the communications interface information from an external server and updating the communications interface information list.

4. The information processing device as set forth in claim 1, further comprising a communications interface information transmit section for obtaining the communications interface information from an external server storing the communications interface information for a transmission to the other information processing device.

5. An information processing device communicably connected to another information processing device, comprising:
an information processing device communications interface information storage section for storing information processing device communications interface information representing a relationship between communications interface information which is information related to a driver and/or hardware of a communications interface with respect to the information processing device and a communicable transmission rate;
an information processing device communications interface check section for checking a transmission rate of a communications interface of the information processing device on the basis of communications interface information of the information processing device; and
a transmission rate setting alteration request section for requesting the other information processing device to alter a transmission rate setting of a communications interface of the other information processing device in accordance with a result of the checking by the information processing device communications interface check section.

6. The information processing device as set forth in claim 5, further comprising a device driver controlling the other information processing device,
wherein:
the device driver stores a correspondent compatibility information list representing a relationship between the sets of communications interface information and a communicable transmission rate with respect. to the other information processing device; and
the information processing device communications interface check section checks a transmission rate at which the communications interface of the information processing device can communicate with the other information processing device on the basis of the information processing device communications interface information and the correspondent compatibility information list.

7. The information processing device as set forth in claim 5, further comprising an information processing device communications interface information obtaining section for obtaining the communications interface information of the information processing device from the external server for storage in the information processing device communications interface information storage section.

8. The information processing device as set forth in claim 5, further comprising a communications interface information transmit section for obtaining the communications interface information from an external server storing the communications interface information for a transmission to the other information processing device.

9. An information processing system configured so that an information processing device is communicably connected to another information processing device,
wherein:
the information processing device comprises:
a communications interface list storage section for storing a communications interface information list recording a relationship between multiple sets of communications interface information which are information related to a driver and/or hardware of a communications interface and a communicable transmission rate;
a correspondent communications interface information obtaining section for requesting and obtaining correspondent communications interface information which is communications interface information on a communications interface of the other information processing device from the other information processing device;
a correspondent communications capability check section for checking a transmission rate capability of the communications interface of the other information processing device in reference to the correspondent communications interface information and the communications interface information list; and
a transmission rate determine section for determining a setting related to a transmission rate of a communications interface of the information processing device in accordance with a result of the checking by the correspondent communications capability check section, and
the other information processing device comprises:
an information processing device communications interface information storage section for storing information processing device communications interface information which is communications interface information of the other information processing device; and
an information processing device communications interface information transmit section for transmitting the information processing device communications interface information in accordance with a request from the information processing device.

10. An information processing system configured so that an information processing device is communicably connected to another information processing device,
wherein:
the information processing device comprises:
an information processing device communications interface information storage section for storing information processing device communications interface information which is information related to a driver and/or hardware of a communications interface with respect to the information processing device;
an information processing device communications interface check section for checking a communicable transmission rate of the communications interface of the information processing device on the basis of the communications interface information of the information processing device; and
a transmission rate setting alteration request section for requesting the other information processing device to alter a transmission rate setting of a communications interface of the other information processing device in accordance with a result of the checking by the information processing device communications interface check section, and
the other information processing device comprises:
a setting alteration request receiving section for receiving a request from the information processing device to alter in relation to the transmission rate setting of the communications interface of the other information processing device; and
a transmission rate determine section for determining the transmission rate setting of the communications interface of the other information processing device in accordance with the received setting alteration request.

11. A transmission rate setting method for an information processing device communicably connected to another information processing device, the information processing device storing a communications interface information list recording a relationship between multiple sets of communications interface information which are information related to a driver and/or hardware of a communications interface and a communicable transmission rate,
the method comprising:
the correspondent communications interface information obtain step of obtaining correspondent communications interface information which is communications interface information of the other information processing device from the other information processing device;
the communications interface capability check step of comparing the correspondent communications interface information with the communications interface information list to check a communicable transmission rate of the communications interface of the other information processing device; and
the transmission rate decide step of deciding a transmission rate of a communications interface of the information processing device in accordance with a result of checking in the communications interface capability check step.

12. A transmission rate setting program causing an information processing device to operate, the information processing device being communicably connected to another information processing device, the information processing device comprising: a communications interface list storage section for storing a communications interface information list recording a relationship between multiple sets of communications interface information which are information related to a driver and/or hardware of a communications interface and a communicable transmission rate; a correspondent communications interface information obtaining section for requesting and obtaining correspondent communications interface information which is communications interface information on a communications interface of the other information processing device from the other information processing device; a correspondent communications capability check section for checking a communicable transmission rate of the communications interface of the other information processing device in reference to the correspondent communications interface information and the communications interface information list; and a transmission rate determine section for determining a setting related to a transmission rate of a communications interface of the information processing device in accordance with a result of the checking by the correspondent communications capability check section,
wherein the program causes a computer to function as the sections.

13. A computer-readable storage medium containing a transmission rate setting program causing an information processing device to operate, the information processing device being communicably connected to another information processing device, the information processing device comprising: a communications interface list storage section for storing a communications interface information list recording a relationship between multiple sets of communications interface information which are information related to a driver and/or hardware of a communications interface and a communicable transmission rate; a correspondent communications interface information obtaining section for requesting and obtaining correspondent communications interface information which is communications interface information on a communications interface of the other information processing device from the other information processing device; a correspondent communications capability check section for checking a communicable transmission rate of the communications interface of the other information processing device in reference to the correspondent communications interface information and the communications interface information list; and a transmission rate determine section for determining a setting related to a transmission rate of a communications interface of the information processing device in accordance with a result of the checking by the correspondent communications capability check section, wherein the program causes a computer to function as the sections.

14. A transmission rate setting program causing an information processing device to operate, the information processing device being communicably connected to another information processing device, the information processing device comprising: an information processing device communications interface information storage section for storing information processing device communications interface information representing a relationship between communications interface information which is information related to a driver and/or hardware of a communications interface with respect to the information processing device and a communicable transmission rate; an information processing device communications interface check section for checking a transmission rate of a communications interface of the information processing device on the basis of communications interface information of the information processing device; and a transmission rate setting alteration request section for requesting the other information processing device to alter a transmission rate setting of a communications interface of the other information processing device in accordance with a result of the checking by the information processing device communications interface check section, wherein the program causes a computer to function as the sections.

15. A computer-readable storage medium containing a transmission rate setting program causing an information processing device to operate, the information processing device being communicably connected to another information processing device, the information processing device comprising: an information processing device communications interface information storage section for storing information processing device communications interface information representing a relationship between communications interface information which is information related to a driver and/or hardware of a communications interface with respect to the information processing device and a communicable transmission rate; an information processing device communications interface check section for checking a transmission rate of a communications interface of the information processing device on the basis of communications interface information of the information processing device; and a transmission rate setting alteration request section for requesting the other information processing device to alter a transmission rate setting of a communications interface of the other information processing device in accordance with a result of the checking by the information processing device communications interface check section, wherein the program causes a computer to function as the sections.
